(19) United States
(12) Patent Application Publication
(10) Pub. No.: US 2024/0055176 A1
(43) Pub. Date: Feb. 15, 2024

(54) INDUCTOR AND BODY PART FOR INDUCTOR

(71) Applicant: POINT ENGINEERING CO., LTD., Chungcheongnam-do (KR)

(72) Inventors: Bum Mo AHN, Gyeonggi-do (KR); Seung Ho PARK, Gyeonggi-do (KR); Sung Hyun BYUN, Gyeonggi-do (KR)

(73) Assignee: POINT ENGINEERING CO., LTD., Chungcheongnam-do (KR)

(21) Appl. No.: 18/267,098

(22) PCT Filed: Dec. 22, 2021
(86) PCT No.: PCT/KR2021/019652

§ 371 Date: Jun. 14, 2023

(30) Foreign Application Priority Data
Dec. 23, 2020 (KR) 10-2020-0182593

(51) Int. Cl. H01F 27/28; H01F 27/02

(52) U.S. Cl. CPC H01F 27/2828; H01F 27/02

(57) ABSTRACT

An inductor and a body part for an inductor are proposed. The inductor and the body part satisfy needs for miniaturization and low resistance and increase a value of inductance thereof.

### CROSS-REFERENCE TO RELATED APPLICATION

This application is a 371 application of an international PCT application serial no. PCT/KR2021/019652, filed on Dec. 22, 2021, which claims the priority benefit of Korean application KR10-2020-0182593, filed on Dec. 23, 2020. The entirety of the above-mentioned patent application is hereby incorporated by reference herein and made a part of this specification.

### TECHNICAL FIELD

The present disclosure relates to an inductor and a body part for an inductor.

### BACKGROUND ART

An inductor is a passive component that utilizes the action of electromagnetic waves generated by passing a current through a wire wound around a core. Various inductors are being developed for high-frequency circuits, general circuits, decoupling circuits, and power supply circuits. Variable inductors whose inductance changes exist, but most of the inductors are fixed inductors. The inductors are divided into lead type and surface mount type in terms of shape, and are divided into winding type, laminated type, and thin film type in terms of structure.

The inductor can be combined with a capacitor to form a resonance circuit, or be used in a filter circuit to filter a specific signal or be used for impedance matching. Recently, with the development of electronic and communication devices, problems such as environment pollution and communication disorders have occurred. Accordingly, technology of electronic and communication devices is developing in terms of function complexity, high integration, and high efficiency.

As miniaturization and high performance of electronic and communication devices are accelerated, it is required to suppress heat generated by miniaturization and low resistance of used parts or devices. Therefore, research is needed to reduce the size and resistance of the inductor used in electronic and communication devices.

A winding type inductor being developed so far is manufactured through the following process. A conducting wire is heat-bonded to maintain a winding shape, the conducting wire is wound to form a coil device part, the coil device part is embedded in a magnetic core in the form of a slurry, and the magnetic core is pressed and hardened. A thin film type inductor is manufactured through the following process. A support member is provided to form a conductive layer on upper and lower surfaces of the support member, a coil pattern is formed by patterning, and a magnetic sheet is laminated on the support member and pressed and cured to form a magnetic body. A laminated type inductor is manufactured through the following process. A via is formed by punching a ceramic sheet using a laser, multiple ceramic sheets on which conductive metal is printed in conductor patterns to fill the via are laminated, and laminated sheets are plastic-deformed and integrated.

However, the structure of the inductor manufactured through the above processes has limits in satisfying the needs of miniaturization and low resistance demanded by the market, and has a limit in increasing a value of inductance of the inductor.

### DOCUMENTS OF RELATED ART

(Patent Document 1) Korean Patent Application Publication No. 10-2020-0115286; and
(Patent Document 2) Korean Patent No. 10-2093558.

### DISCLOSURE OF INVENTION

### Technical Problem

Accordingly, the present disclosure has been made keeping in mind the above problems occurring in the related art, and the present disclosure is intended to provide an inductor and a body part for an inductor, the inductor being configured to satisfy needs for miniaturization and low resistance.

Meanwhile, a further objective of the present disclosure is intended to provide an inductor and the body part for an inductor, the inductor being configured to increase a value of inductance thereof.

### Solution to Problem

In order to accomplish the above object, the present disclosure provides an inductor including a body and a coil part, wherein the coil part may include: a plurality of vertical connection portions passing through the body; upper connection portions provided above the body and connecting the vertical connection portions to each other; and lower connection portions provided at a lower portion of the body and connecting the vertical connection portions to each other.

The body may be made of a glass material.

The body may be made of an anodic oxide film material.

The vertical connection portions may include: first column vertical connection portions located at a first side of the body; and second column vertical connection portions located at a second side of the body, wherein, when the first column vertical connection portions are reflected toward the second column vertical connection portions, the first column vertical connection portions may be located between the second column vertical connection portions.

A magnetic part may be provided in the coil part.

The inductor may include: a first passivation layer provided between the magnetic part and the upper connection portions; and a second passivation layer provided between the magnetic part and the lower connection portions.

The magnetic part may consist of one bulk.

The magnetic part may include a plurality of magnetic column portions.

The inductor may include: a cover part provided in at least any one of an upper portion and a lower portion of the plurality of magnetic column portions and connecting the magnetic column portions to each other.

The magnetic part may be embedded in the body.

An inductor including a body and a coil part, wherein the coil part may include: a plurality of vertical connection portions passing through the body; upper connection portions provided above the body and connecting the vertical connection portions to each other; and lower connection portions provided at a lower portion of the body and connecting the vertical connection portions to each other, wherein the body has a thickness that is equal to or greater than 100 μm and less than or equal to 200 μm, each of the vertical connection portions has a width that is equal to or greater than 1 μm and less than or equal to 10 μm, each of the upper connection portions has a width that is equal to or greater than 1 μm and less than or equal to 10 μm, and each of the lower connection portion has a width equal to or greater than 1 μm and less than or equal to 10 μm.

An inductor including a body and a coil part, wherein the coil part may include: a plurality of vertical connection portions passing through the body; upper connection portions provided above the body and connecting the vertical connection portions to each other; and lower connection portions provided at a lower portion of the body and connecting the vertical connection portions to each other, a space between the first column vertical connection portions located at the first side of the body has a distance equal to or greater than 1 μm and less than or equal to 10 μm, and a space between the second column vertical connection portions located at the second side of the body has a distance equal to or greater than 1 μm and less than or equal to 10 μm.

An inductor including a body and a coil part, wherein the coil part may include: a plurality of vertical connection portions passing through the body; upper connection portions provided above the body and connecting the vertical connection portions to each other; and lower connection portions provided at a lower portion of the body and connecting the vertical connection portions to each other, wherein a pitch distance in the coil part may be equal to or greater than 1 μm and less than or equal to 10 μm.

An inductor may include: a body made of an anodic oxide film material; a coil part including a plurality of vertical connection portions passing through the body and horizontal connection portions provided on a surface of the body and connecting the vertical connection portions to each other; and a magnetic part provided in the body and located inside the coil part.

The inductor may include: a passivation layer provided between the magnetic part and the coil part.

Each of the vertical connection portions and each of the horizontal connection portions may have sectional areas that may be identical.

The present disclosure provides a body part for an inductor, the body part including: a body formed of an anodic oxide film material, and including vertical through parts vertically passing through the anodic oxide film.

An electric conductive material may be filled in the vertical through parts to provide vertical connection portions.

The body part for an inductor may include: upper connection portions connecting upper portions of the vertical connection portions to each other; and lower connection portions connecting lower portions of the vertical connection portions to each other.

The vertical connection portions may include: first column vertical connection portions located at a first side of the body; and second column vertical connection portions located at a second side of the body, wherein a magnetic part is provided between the first column vertical connection portions and the second column vertical connection portions in the body.

The magnetic part may include magnetic column portions provided at pores of the anodic oxide film.

The body part for an inductor may include: a passivation layer provided on the magnetic part.

The body may have a thickness that may be equal to or greater than 100 μm and less than or equal to 300 μm, and each of the vertical through parts may have a width that may be equal to or greater than 1 μm and less than or equal to 20 μm, and a space between the vertical through parts arranged in a column direction may have a distance that may be equal to or greater than 1 μm or less than or equal to 50 μm.

Each of the vertical through parts may have a polygonal horizontal section.

### Advantageous Effects of Invention

As described above, the present disclosure provides the inductor and the body part for an inductor, and the inductor and the body part can satisfy needs for miniaturization and low resistance and can increase a value of inductance thereof.

Furthermore, the present disclosure provides the inductor and the body part for an inductor, and the inductor and the body part can increase a value of inductance thereof.

### BRIEF DESCRIPTION OF DRAWINGS

FIG. 1A is a plan view showing an exemplary first embodiment of the present disclosure;

FIG. 1B is a sectional view taken along line A-A′ in FIG. 1A;

FIGS. 1C and 1D are views showing the exemplary first embodiment of present disclosure, wherein a magnetic part is omitted to expose lower connection portions;

FIG. 1E is a view showing a structure of vertical connection portions according to the exemplary first embodiment of the present disclosure;

FIGS. 1F and 1G are views showing an arrangement structure of the vertical connection portions according to the exemplary first embodiment of the present disclosure;

FIGS. 2A to 8B are views showing a manufacturing process of the exemplary first embodiment of the present disclosure;

FIG. 9A is a plan view showing an exemplary second embodiment of the present disclosure;

FIG. 9B is a sectional view taken along line A-A′ in FIG. 9A;

FIGS. 10A to 15B are views showing a manufacturing process according to the exemplary second embodiment of the present disclosure;

FIG. 16A is a plan view showing an exemplary third embodiment of the present disclosure;

FIG. 16B is a sectional view taken along line A-A′ in FIG. 16A; and

FIGS. 17 to 20B are views showing a manufacturing process according to the exemplary third embodiment of the present disclosure.

### MODE FOR THE INVENTION

In the following description, only the theory of the present disclosure will be described. Thus, although some embodiments are not clearly described in the following description or not clearly shown in the accompanying drawings, those skilled in the art can provide various apparatuses that may be configured to embody the theory of the present disclosure within the scope and spirit thereof Further, the terminology used herein is for the purpose of describing particular aspects or embodiments of the present disclosure only and is not intended to be limiting of the present disclosure.

The above and other objectives, features, and other advantages of the present disclosure will be more clearly understood from the following detailed description when taken in conjunction with the accompanying drawings, and those skilled in the art will easily understand and may embody the scope and spirit of the invention.

Embodiments described herein will be described with reference to cross-sectional and/or perspective views, which are ideal illustrative drawings of the present disclosure. The thicknesses of films and regions shown in the drawings are exaggerated for effective description of technical content. The shape of the illustrative drawing may be modified due to manufacturing technology and/or tolerance. In addition, the number of moldings shown in the drawings is only partially shown in the drawings as an example. Therefore, embodiments of the present disclosure are not limited to the specific form shown in the drawings, but also include a change in a form generated according to a manufacturing process.

In describing various embodiments, the same names and reference numerals are given to components performing the same functions for convenience even when the embodiments are different. Furthermore, configurations and operations already described in other embodiments will be omitted for convenience.

First, a first embodiment of the present disclosure will be described.

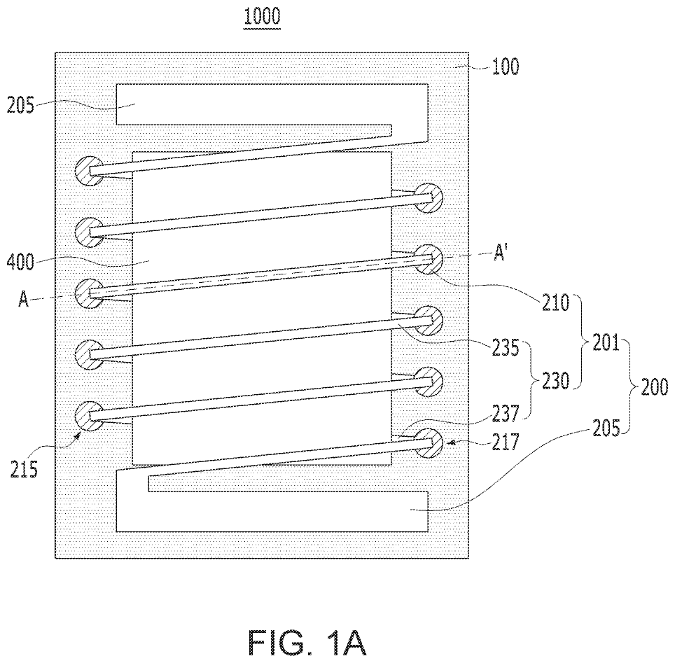

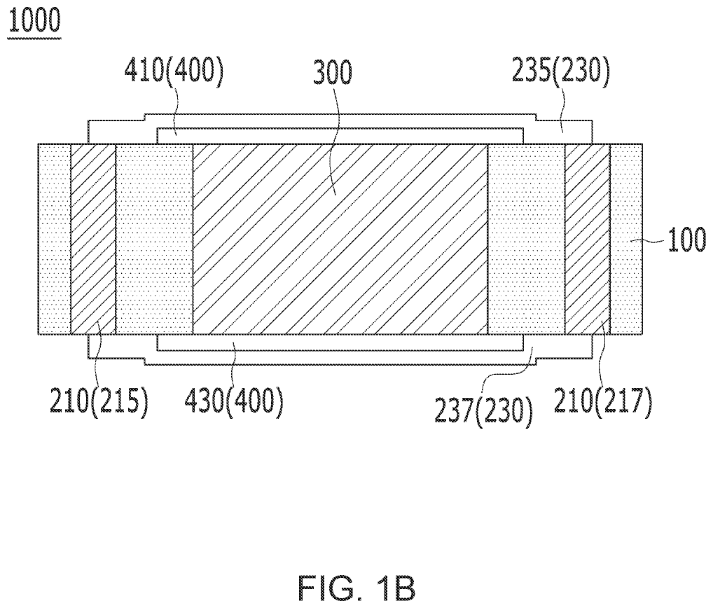

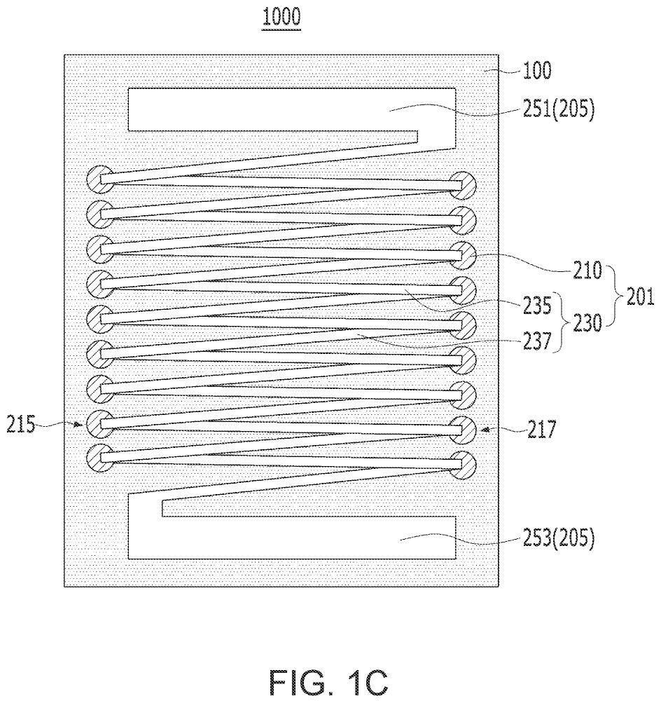

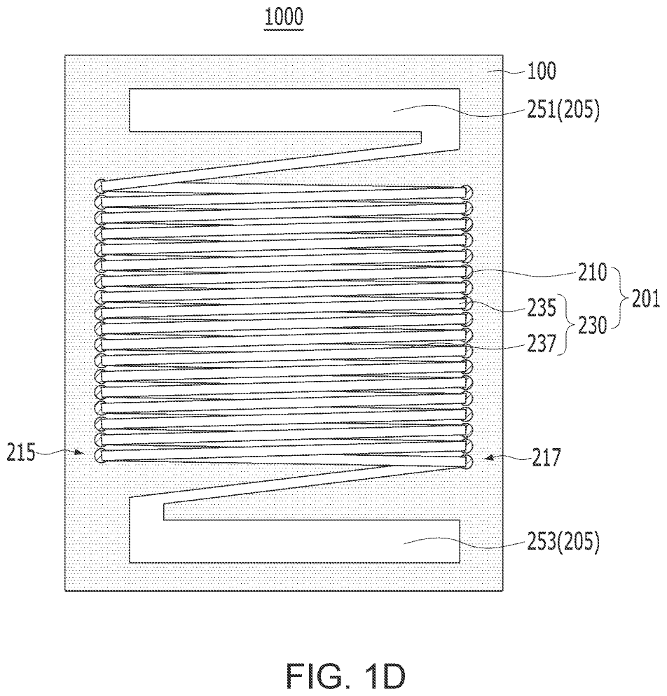

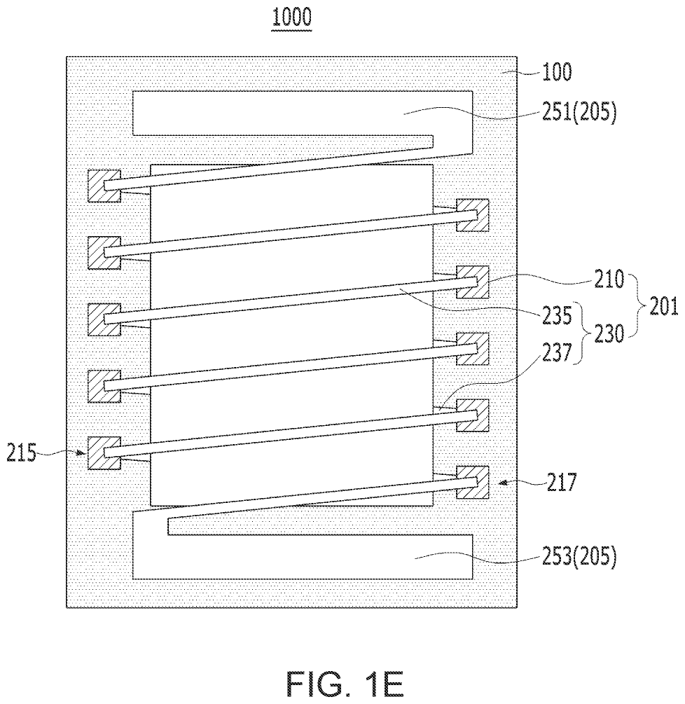

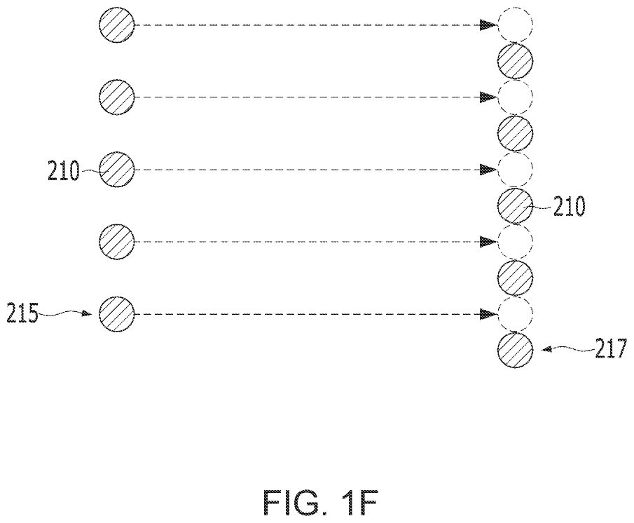

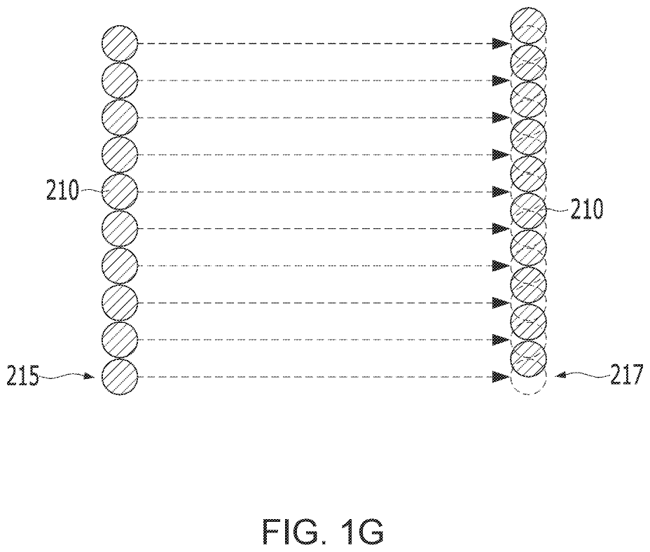

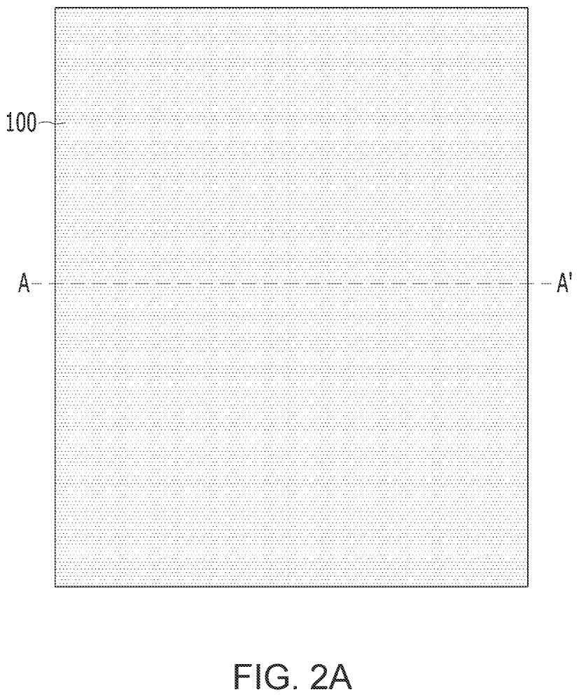

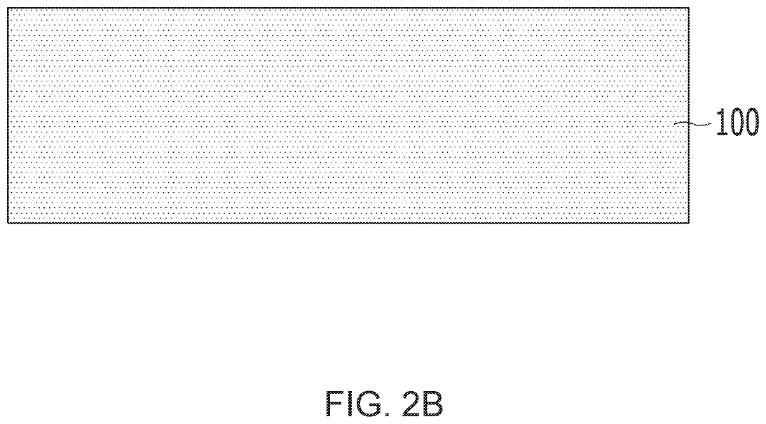

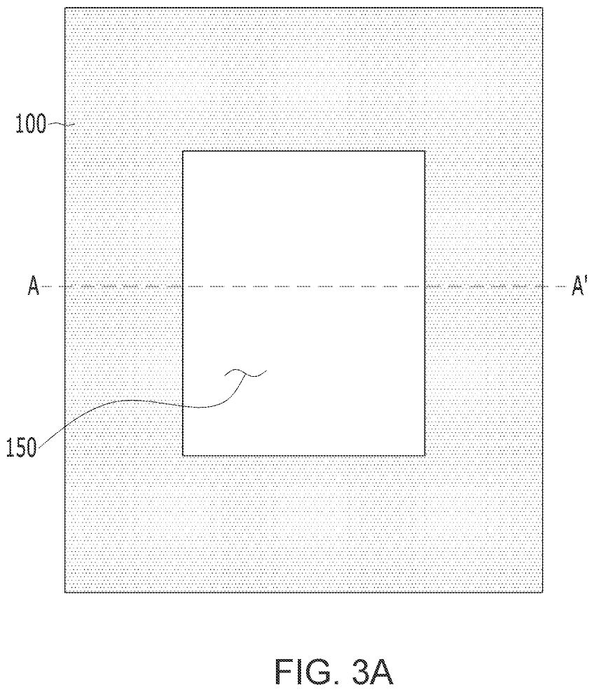

FIG. 1A is a plan view showing an exemplary first embodiment of the present disclosure. FIG. 1B is a sectional view taken along line A-A′ in FIG. 1A. FIGS. 1C and 1D are views showing the exemplary first embodiment of present disclosure, wherein a magnetic part is omitted to expose lower connection portions. FIG. 1E is a view showing a structure of vertical connection portions according to the exemplary first embodiment of the present disclosure. FIGS. 1F and 1G are views showing an arrangement structure of the vertical connection portions according to the exemplary first embodiment of the present disclosure. FIGS. 2A to 8B are views showing a manufacturing process of the exemplary first embodiment of the present disclosure. In FIGS. 2A to 8B, ‘A’ is a plan view, and ‘B’ is a sectional view taken along line A-A′.

For example, FIG. 1A shows the lower connection portions 237 of FIG. 1B. Referring to FIGS. 1A and 1, an inductor 1000 according to a first embodiment of the present disclosure includes a body 100 and a coil part 200. The coil part 200 includes a plurality of vertical connection portions 210 passing through the body 100 and horizontal connection portions 230 connecting the plurality of vertical connection portions to each other.

The coil part 200 consists of an electric conductive material. Preferably, the coil part 200 may be made including metal having high electric conductivity. For example, a material forming the coil part 200 includes silver (Ag), palladium (Pd), aluminum (Al), nickel (Ni), titanium (Ti), gold (Au), copper (Cu), platinum (Pt), or alloy thereof.

The coil part 200 includes a coil portion 201 and a pad portion 205. The pad portion 205 includes a first pad portion 251 connected to a first end of the coil portion 201 and a second pad portion 253 connected to a second end of the coil portion 201. The coil portion 201 is formed between the first and second pad portions 251 and 253. The first pad portion 251 is connected to a first external electrode (not shown). The second pad portion 253 is connected to a second external electrode (not shown). The first and second external electrodes (not shown) are made of Cu, Ni, tin (Sn), or an allow material thereof. Both the first and second pad portions 251 and 253 may be provided at the same surface of the body 100, for example, at an upper surface thereof. However, the present disclosure is not limited thereto.

The coil portion 201 includes the plurality of vertical connection portions 210 passing through the body 100 and the horizontal connection portions 230 connecting the vertical connection portions 210 to each other. As the horizontal connection portions 230 are provided outside the body 100 and the vertical connection portions 210 are provided inside the body 100, the coil portion 201 is formed to be wound around a part of the body 100.

The vertical connection portions 210 may be formed such that the electric conductive material is filled into vertical through parts 130 vertically penetrating the body 100. The vertical connection portions 210 includes first column vertical connection portions 215 located a first side of the body 100 and second column vertical connection portions 217 located at a second side of the body 100. The vertical connection portions 210 arranged in a column direction are arranged to be spaced apart from each other at predetermined distances.

The horizontal connection portions 230 are provided on a surface of the body 100 and be made of the electric conductive material, and may be made of the same material as the vertical connection portions 210. The horizontal connection portions 230 include upper connection portions 235 and the lower connection portions 237. Each of the upper connection portions 235 connects the vertical connection portions 210 to each other while being located above the body 100 and each of the lower connection portions 237 connects the vertical connection portions 210 to each other while being located below the body 100.

Each of the upper connection portions 235 is configured to connect any one vertical connection portion 210 of the first column vertical connection portions 215 to one vertical connection portion 210 of the second column vertical connection portions 217 located at the shortest distance from the any one vertical connection portion 210. Based on FIG. 1A, the upper connection portions 235 may be provided in a diagonal line having an upward inclination. The vertical connection portions 210 arranged in a column direction are arranged to be spaced apart from each other at predetermined distances. Therefore, upper connection portions 235 may have inclinations with the same angles.

Each of the lower connection portions 237 is configured to connect any one vertical connection portion 210 of the second column vertical connection portions 217 to one vertical connection portion 210 of the first column vertical connection portions 215 located at the shortest distance from the any one vertical connection portion. Based on FIG. 1A, the lower connection portions 237 may be arranged in a diagonal line having a leftward upward inclination. Furthermore, lower connection portions 237 may have inclinations having the same angles.

The upper connection portions 235 and the lower connection portions 237 are connected to each other through the vertical connection portions 210. Therefore, there is a shape in which the coil is wound while passing through the body 100 through the vertical connection portions 210. An inside area of the coil part 200 formed by the first and second vertical connection portions 215 and 217 and the upper and lower connection portions 235 and 237 has a rectangular sectional shape.

FIG. 1F is a view showing the first column vertical connection portions 215 when the first column vertical connection portions 215 are reflected toward the second column vertical connection portions 217. As shown in FIG. 1F, when the first column vertical connection portions 215 are reflected toward the second column vertical connection portions 217, each of the first column vertical connection portions 215 is located between the second column vertical connection portions 217. When two vertical connection portions 210 adjoin each other in the first column vertical connection portions 215 are reflected toward the second column vertical connection portions 217 and one second column vertical connection portion 217 between the two vertical connection portions 210 and the two vertical connection portions 210 are connected to each other by imaginary lines, the imaginary lines are diagonal lines of an isosceles triangle. Accordingly, a difference between a magnetic flux direction generated by the lower connection portions 237 and a magnetic flux direction generated by the upper connection portions 235 is minimized thus securing stable inductance. Furthermore, as the upper connection portions 235 and the lower connection portions 237 are formed to have the same lengths, the time for a current to pass through the upper connection portions 235 and the time for a current to pass through the lower connection portions 237 becomes identical, whereby stable inductance may be secured.

A magnetic part 300 is provided in the coil part 200. As the magnetic part 300 is provided in the coil part 200 to increase magnetic permeability, inductance of the inductor 1000 may be increased. The magnetic part 300 is provided in the body 100 and located inside the coil part 200.

The magnetic part 300 is made of a magnetic material. The magnetic part 300 may be formed by being filled with ferrite or metal magnetic material powder. For example, the magnetic part 300 includes Mn—Zn-based ferrite, Ni—Zn-based ferrite, Ni—Zn—Cu-based ferrite, Mn—Mg-based ferrite, Ba-based ferrite or Li-based ferrite, etc., and may include at least any one selected from the group consisting of Fe, Si, Co, Cr, Al and Ni, and may be Fe—Co-based metal or Fe—Si—B—Cr-based metal, but the present disclosure is not limited thereto.

Referring to FIG. 1B, the magnetic part 300 is provided in the body 100. The magnetic part 300 may be provided in one bulk shape between the first column vertical connection portions 215 and the second column vertical connection portions 217. However, the present disclosure is not limited thereto, and the magnetic part 300 may be formed such that a plurality of bulk shapes is arranged at predetermined intervals and upper and lower portions of the bulk shapes are connected to each other.

A passivation layer 400 is provided between the magnetic part 300 and each of the horizontal connection portions 230. The passivation layer 400 may serve to insulate between the magnetic part 300 and the horizontal connection portions 230. In this case, the passivation layer 400 may be an insulation material. The magnetic part 300 is prevented from being exposed outward by the passivation layer 400 and is insulated from external components.

The passivation layer 400 covers the magnetic part 300 while being located at an area between the first column vertical connection portions 215 and the second column vertical connection portions 217.

The passivation layer 400 includes a first passivation layer 410 and a second passivation layer 430. The first passivation layer 410 is located between the magnetic part 300 and the upper connection portions 235 and covers to prevent an upper surface of the magnetic part 300 from being exposed outward. The second passivation layer 430 is located between the magnetic part 300 and the lower connection portions 237 and covers to prevent a lower surface of the magnetic part 300 from being exposed outward.

The body 100 may be formed of a glass material or an anodic oxide film material, and the present disclosure is not limited thereto.

A material of the body 100 may be made of the anodic oxide film material. The anodic oxide film means a film formed by anodizing the base metal, and the pores mean holes formed in the process of forming the anodic oxide film by anodizing metal. For example, when the base metal is aluminum (Al) or an aluminum alloy, the anodic oxide film made of aluminum oxide (Al₂O₃) is formed on a surface of the base material when the base material is anodized. The anodic oxide film is divided into a barrier layer in which the pores are not vertically formed and a porous layer in which pores are formed. When the base material is removed from the base material formed on the surface of the anodic oxide film having the barrier layer and the porous layer, only the anodic oxide film made of aluminum oxide (Al₂O₃) remains.

The anodic oxide film may be formed in a structure in which the barrier layer formed during anodization is removed and the pores be formed to be hollow in vertical direction, or in a structure in which the barrier layer formed during anodization remains and seals one of upper ends or lower ends of the pores.

The anodic oxide film has a coefficient of thermal expansion of 2˜3 ppm/° C. Therefore, when the body 100 is exposed to high temperature environment, thermal deformation due to temperature thereof is small. According to the preferable embodiment of the present disclosure, since the inductor 1000 includes the coil part 200, the inductor 1000 should be prevented from being deformed in response to the temperature of the surrounding environment. The body 100 constituting the inductor 1000 according to the preferable embodiment of the present disclosure is made of the anodic oxide film material, so that thermal deformation of the inductor 1000 may be minimized. Therefore, breakage of the coil of the coil part 200 or a change in the inductance may be prevented. Furthermore, as described in detail in a second embodiment, the body 100 includes air column portion 317s having hollow pores 110. The air column portions 317 serve to insulate between the vertical connection portions 210 and the magnetic part 300. Therefore, the air column portions 317 may prevent heat generated in the coil part 200 from being transmitting to the magnetic part 300 and heat generated in the magnetic part 300 from being transmitted to the coil part 200.

In order to improve the inductance of the inductor 1000, the number of coil turning of the coil part 200 should be increased, and in order to increase the number of coil turning, the coil of the coil part 200 should be wound many times per unit area. Therefore, making the body 100 the material of the anodic oxide film is preferable in terms of increasing the inductance of the inductor. The present disclosure will be described with reference to FIGS. 1C to 1E.

When the vertical through parts 130 are formed in the body 100 by using a laser, the vertical through parts 130 formed by the laser are not formed in vertical shapes to cause a problem in that a flow of current of the coil part 200 is unstable, and to cause a problem in that a crack is easily generated on a periphery of the vertical through parts 130 due to thermal stress caused by a laser thus the vertical through parts 130 may not be formed tightly.

Otherwise, when the body 100 is made of the anodic oxide film material, the anodic oxide film is wet etched using patterned photoresist thus the vertical through parts 130 may be provided. Therefore, inner walls of the vertical through parts 130 have vertical shapes. In other words, it is possible to form the inner walls of the vertical through parts 130 the vertical through parts 130 to have the same sectional areas from lower portions thereof toward upper portions thereof. Therefore, a current flow of the coil part 200 is stable.

Furthermore, since the vertical through parts 130 are formed by wet etching, thermal stress is not generated in formation of the vertical through parts 130, so that the vertical through parts 130 may be formed more tightly. Comparing FIG. 1A to FIG. 1C, the vertical connection portions 210 shown in FIG. 1C are arranged more tightly than the vertical connection portions 210 shown in FIG. 1A. As shown in FIG. 1C, intervals between the vertical connection portions 210 may be reduced, thus increase the number of coiling of the coil part 200. Meanwhile, referring to FIG. 1D, the vertical connection portions 210 having widths smaller than widths of the vertical connection portions 210 shown in FIG. 1C are shown. When the widths of the vertical connection portions 210 are halved, the number of winding of the coil part 200 may be doubled. As a result, the inductance of the inductor 1000 may be quadrupled. When a material of the body 100 is made of the anodic oxide film material, reduction of the widths of the vertical connection portions 210 is possible, so that the inductance of the inductor 1000 may be largely improved.

When the laser is used, there is a limit in reducing the widths of the vertical through parts 130. Specifically, when a thickness of the body 100 is manufactured equal to or greater than 100 μm, it is difficult to form the widths of the vertical through parts 130 manufactured using the laser to be less than or equal to 10 μm. Even if it is possible to manufacture the vertical through parts 130 when using the laser, the inner walls of the vertical through parts 130 are not formed in the vertical shapes and a section with a small width is generated in each of the vertical through parts 130, which are undesirable.

On the other hand, when the body 100 is made of the anodic oxide film material and the vertical through parts 130 are formed by wet etching, the vertical connection portions 210 may be formed to have the widths less than or equal to 10 μm. However, when the vertical connection portions 210 have too small widths, resistance to current flowing in the coil part 200 is increased. Preferably, the widths of the vertical connection portions 210 are formed equal to or greater than 1 μm.

Referring to FIG. 1E, when the body 100 is made of the anodic oxide film material, the vertical through parts 130 are formed by wet etching the anodic oxide film, so that it is possible to form the vertical through parts 130 in other shaped sections, not circular sections. The horizontal connection portions 230 have predetermined height and sections thereof are formed in rectangular shapes. Since the horizontal sections of the vertical connection portions 210 may be formed in the rectangular sections by using wet etching, the horizontal connection portions 230 and the vertical connection portions 210 may be formed to have the same widths, and the horizontal connection portions 230 and the vertical connection portions 210 may also be configured to have the same sectional areas. In the current flowing in the coil part 200, it is preferable that the vertical connection portions 210 and the horizontal connection portions 230 are formed to have the same areas, so that a stable current flow may be secured. Therefore, when the body 100 is made of the anodic oxide film material, it is possible to form the vertical connection portions 210 and the horizontal connection portions 230 to have the same widths or the same areas, so that the stable current flow may be secured.

FIG. 1G is a view showing the first column vertical connection portions 215 when reflecting the first column vertical connection portions 215 toward the second column vertical connection portions 217. As shown in FIG. 1G, when the first column vertical connection portions 215 are reflected toward the second column vertical connection portions 217, some vertical connection portions 210 included in the first column vertical connection portions 215 may be configured to be located between some vertical connection portions 210 included in the second column vertical connection portions 217 and are overlapped with each other. Accordingly, a difference between a magnetic flux direction generated by the lower connection portions 237 and a magnetic flux direction generated by the upper connection portions 235 is minimized thus securing stable inductance. Furthermore, as the number of coil winding of the coil part 200 is increased, the inductance of the inductor may be further increased.

As described above, the body 100 may have the thickness equal to or greater than 100 μm and less than or equal to 200 μm, the vertical connection portions 210 may have the widths equal to greater than 1 μm and less than or equal to 10 μm, the upper connection portions 235 may have the widths equal to or greater than 1 μm and less than or equal to 10 μm, and the lower connection portions 237 may have the widths equal to or greater than 1 μm and less than or equal to 10 μm. Furthermore, a space between the vertical connection portions 210 in the first column vertical connection portions 215 located at the first side of the body 100 may be a distance equal to or greater than 1 μm and less than or equal to 10 μm. A space between the vertical connection portions 210 in the second column vertical connection portions 217 located at the second side of the body 100 may be a distance equal to or greater than 1 μm and less than or equal to 10 μm. Furthermore, the coil part 200 may be formed such that a pitch distance thereof is equal to or greater than 1 μm and less than or equal to 10 μm.

Therefore, the inductor 1000 may be minimized and the number of coil turns of the coil part 200 per unit area may be increased in the minimized structure, so that the inductance of the inductor 1000 may be further improved.

Furthermore, the conventional inductor needs a high temperature process (specifically, high temperature sintering process for laminated inductor), so there may be a restriction on forming the coil part 200 using metal high melting point and high resistance metal. When the body 100 is made of the anodic oxide film material, the high temperature sintering process to the body 100 is not required, so that it is possible to form the coil part 200 by using low resistance metal having high electric conductivity.

Hereinbelow, a manufacturing method according to a first embodiment of the present disclosure will be described with reference to FIGS. 2A to 9B. In FIGS. 2A to 9B, ‘A’ is a plan view, and ‘B’ is a sectional view taken along line A-A′.

First, referring to FIGS. 2A and 2B, the body 100 is prepared. The body 100 may be made of the glass material or the anodic oxide film material, and the present disclosure is not limited thereto.

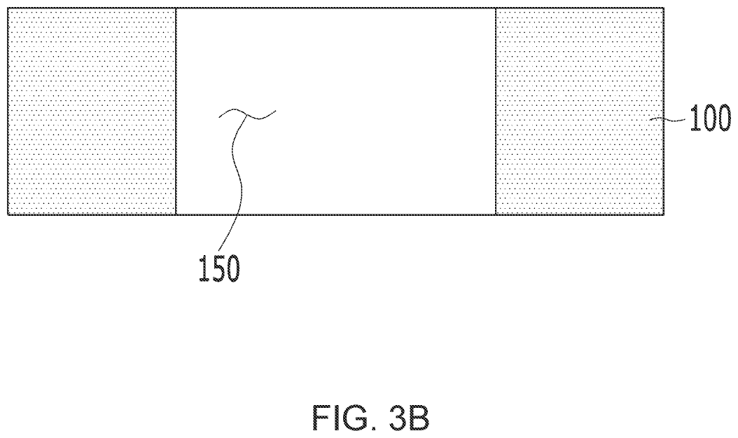

Referring to FIGS. 3A and 3B, the through center portion 150 is provided at a center portion of the body 100. When the body 100 is made of the anodic oxide film material, the through center portion 150 may be formed by etching the anodic oxide film. In this case, a horizontal sectional shape of the through center portion 150 may be a rectangular shape. The through center portion 150 may be formed to have the same height as a height of the body 100.

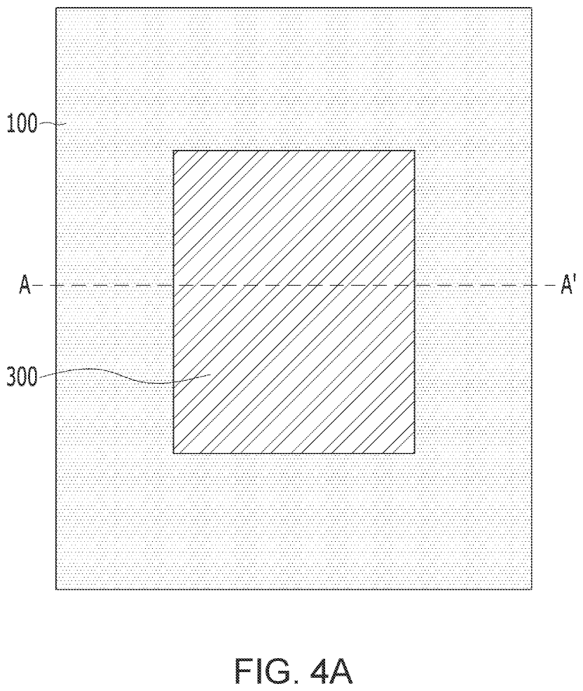

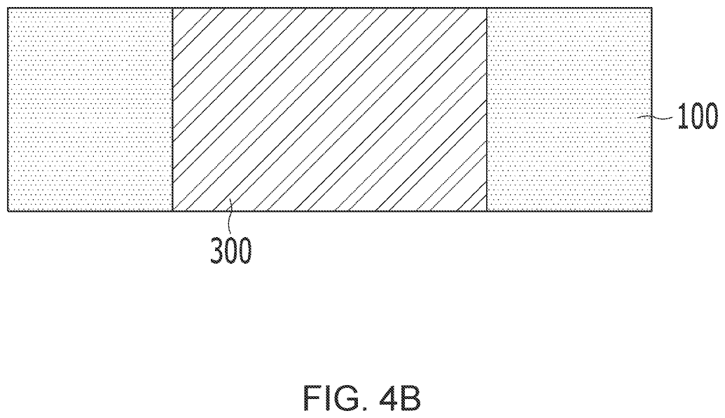

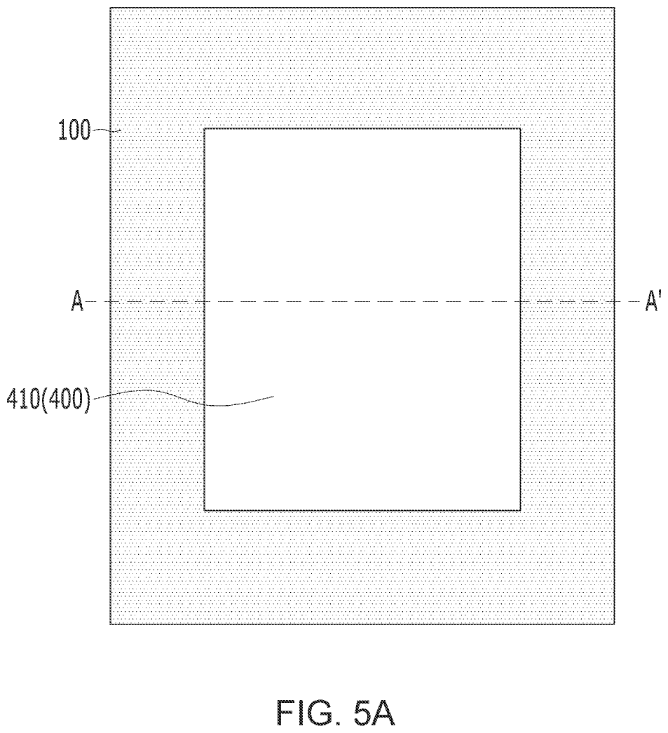

Referring to FIGS. 4A and 4B, the magnetic part 300 is provided in the through center portion 150 of the body 100. The magnetic part 300 is provided while having a shape corresponding to the shape of the through center portion 150. A method of providing the magnetic part 300 in the through center portion 150 may use various methods such as a plating method, an injection method, etc.

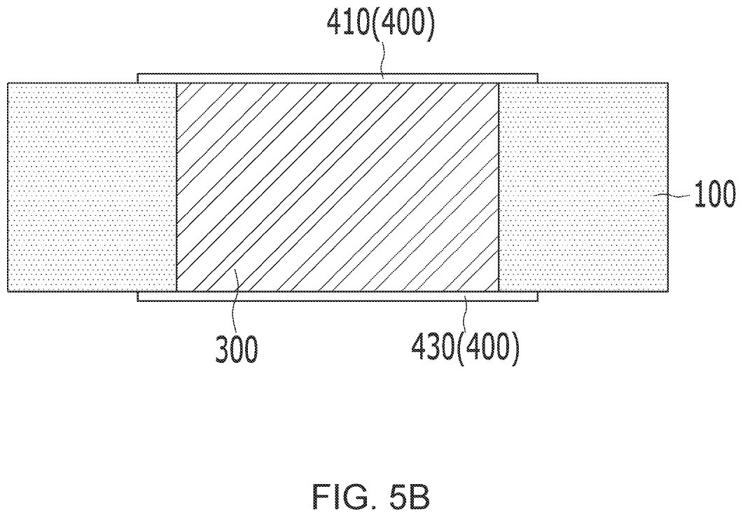

Referring to FIGS. 5A and 5B, the passivation layer 400 is formed on a surface of the magnetic part 300. The passivation layer 400 includes the first passivation layer 410 provided on the upper surface of the magnetic part 300 and the second passivation layer 430 provided on the lower surface of the magnetic part 300.

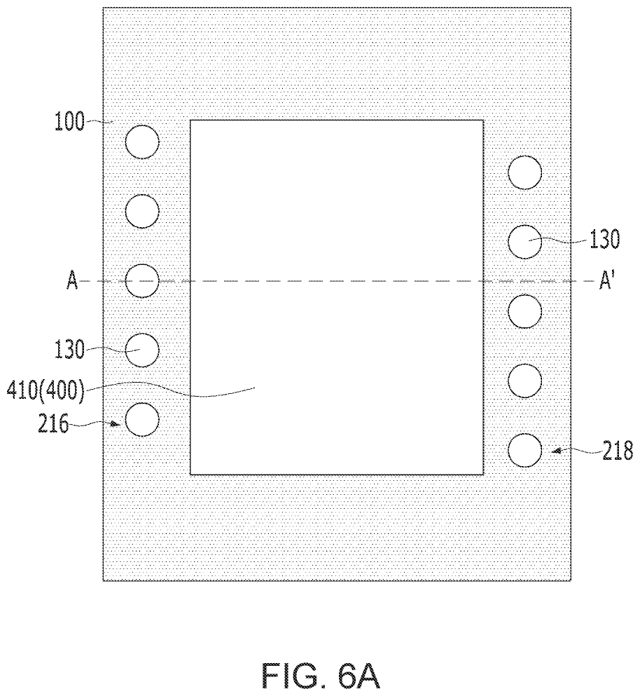

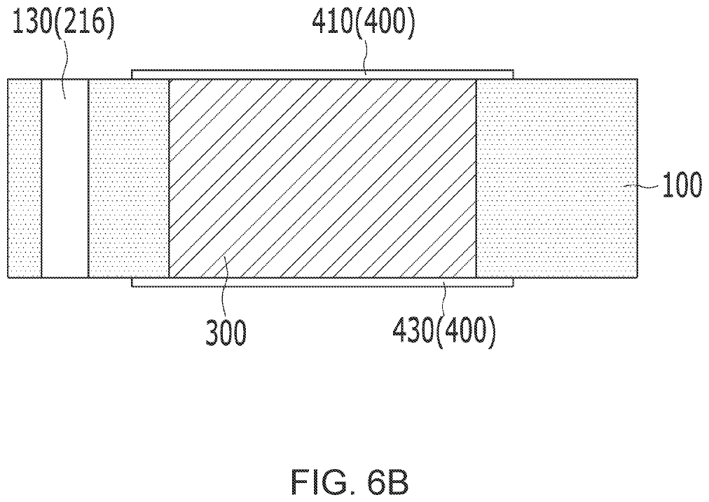

Next, referring to FIGS. 6A and 6B, the vertical through parts 130 are formed. The vertical through parts 130 include first row vertical through parts 216 provided at the left side based on the views and second row vertical through parts 218 provided at the right side based on the views. However, as the order to form the vertical through parts 130, the vertical through parts 130 may be formed in the stage of FIGS. 6A and 6B, or the vertical through parts 130 may be formed with the through center portion 150 in the stage where the through center portion 150 is formed. FIGS. 6A and 6B, each of the vertical through parts 130 is shown as having a circular horizontal section, but the present disclosure is not limited thereto, and the horizontal section of the vertical through part 130 may be formed in a polygonal shape (FIG. 1E).

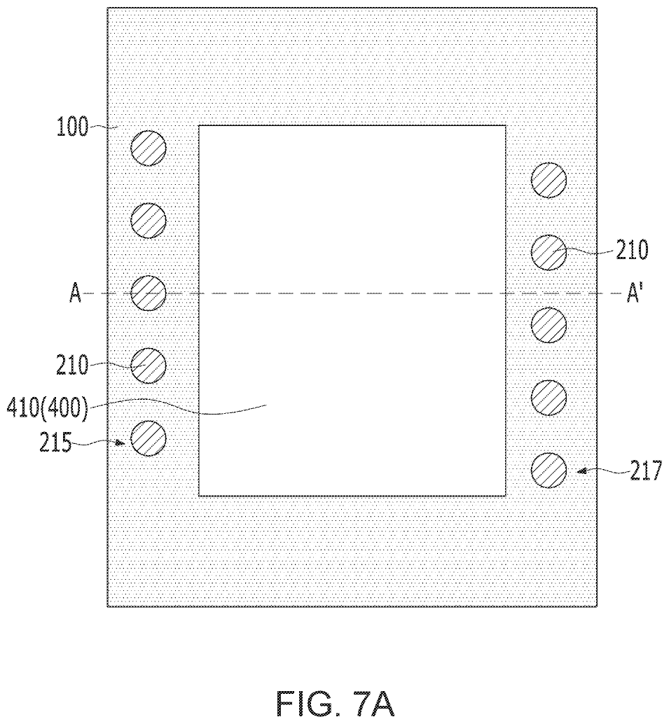

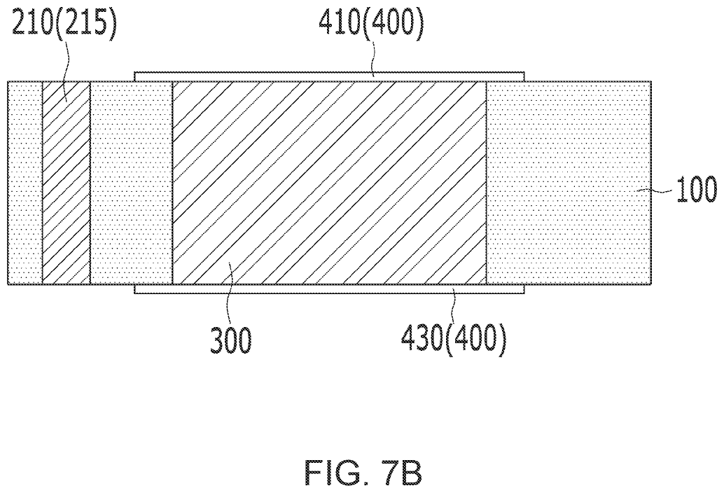

Next, referring to FIGS. 7A and 7B, the vertical connection portions 210 are formed by filling electric conductive material into the vertical through parts 130.

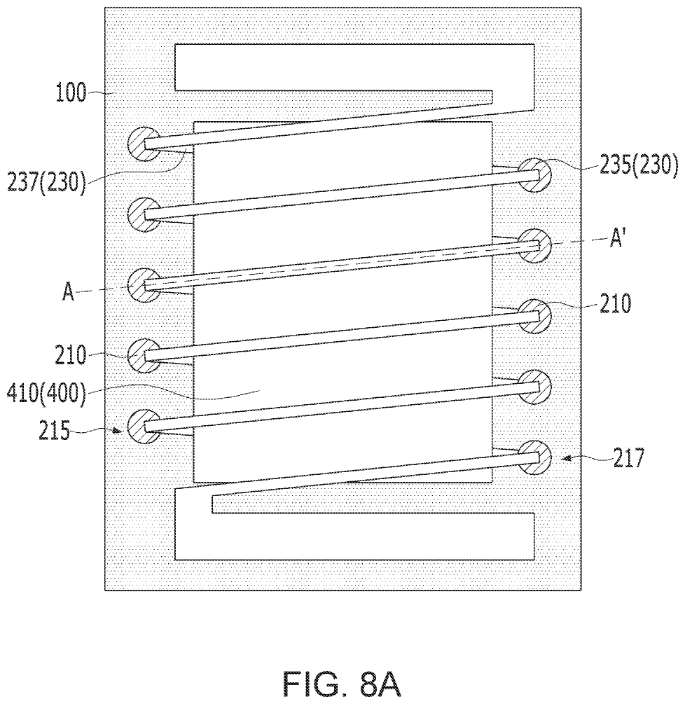

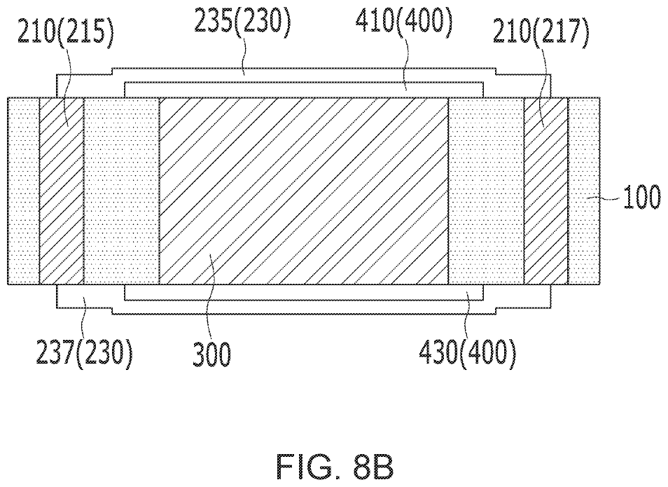

Next, referring to FIGS. 8A and 8B, on the upper surface of the body 100, some of the vertical connection portions 210 included in the first column vertical connection portions 215 and remaining vertical connection portions 210 included in the second column vertical connection portions 217 are connected to each other to form the upper connection portions 235. Furthermore, on the lower surface of the body 100, some of the vertical connection portions 210 included in the first column vertical connection portions 215 and remaining vertical connection portions 210 in the second column vertical connection portions 217 are connected to each other to form the lower connection portions 237.

Meanwhile, in a next stage, additional process may be performed to improve product reliability. For example, an insulation with high rigidity may be additionally formed on the upper and lower surfaces of the body 100. Through the above process, the inductor 1000 according to the first embodiment of the present disclosure is manufactured.

Hereinbelow, a second embodiment according to the present disclosure will be described. However, embodiments described below will be described by focusing on the characteristic components in comparison to the first embodiment, and the same or similar components to the components of the first embodiment will be omitted.

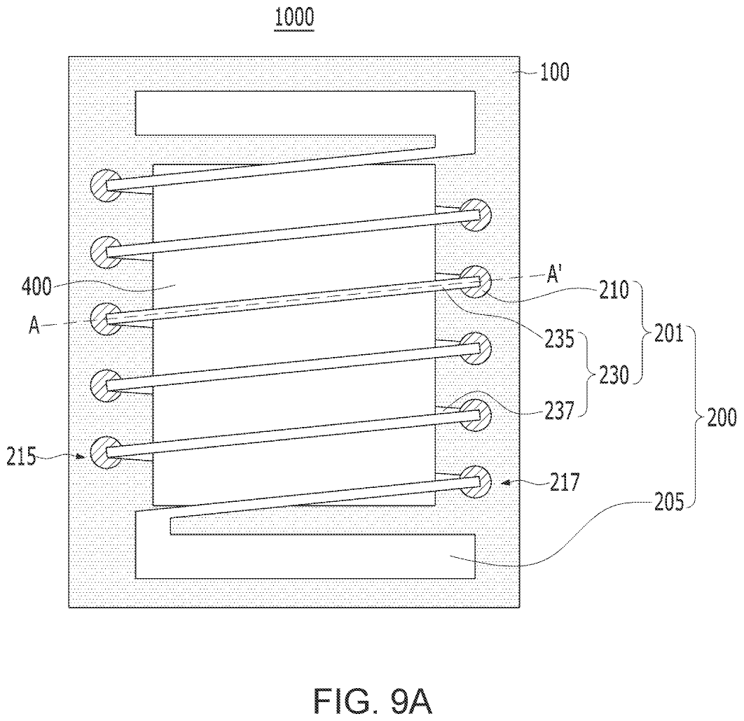

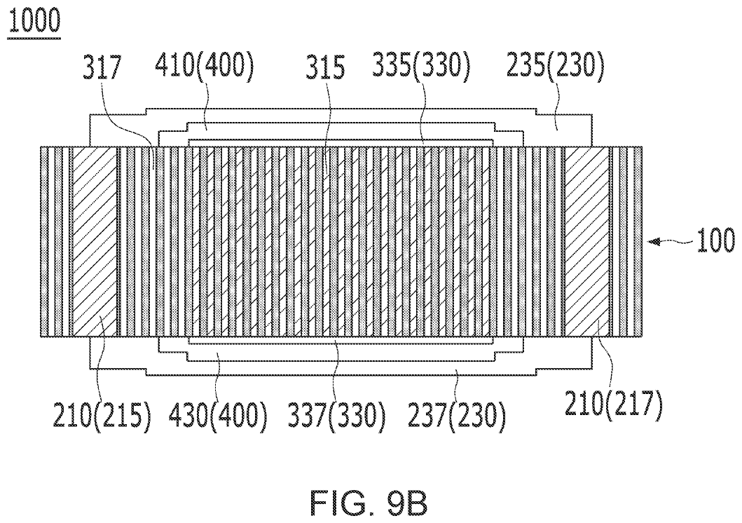

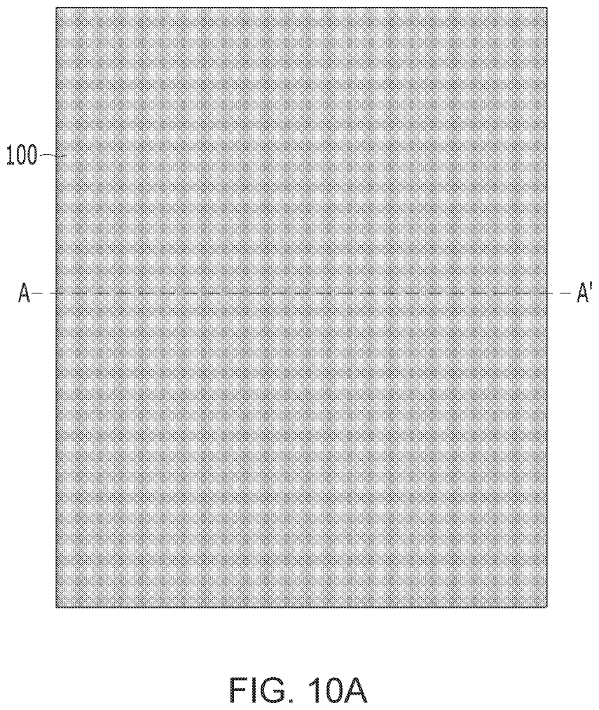

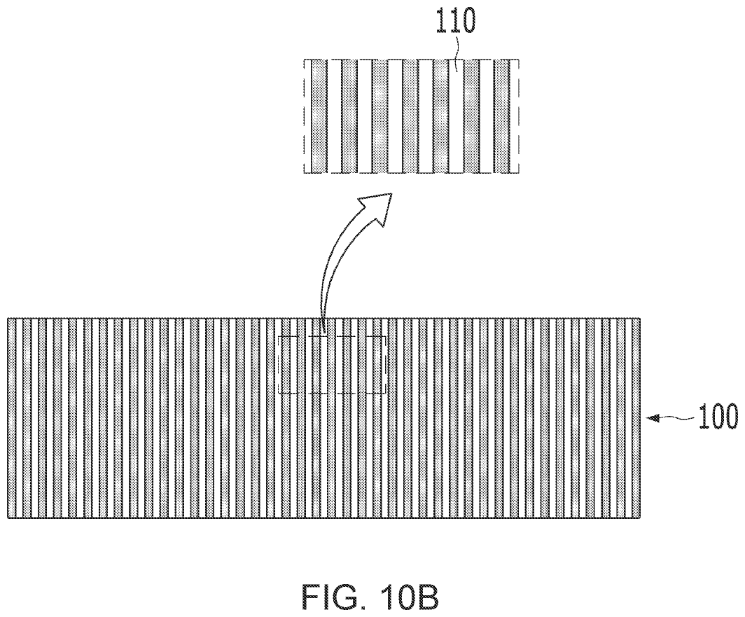

FIG. 9A is a plan view showing an exemplary second embodiment of the present disclosure. FIG. 9B is a sectional view taken along line A-A′ in FIG. 9A. FIGS. 10A to 15B are views showing a manufacturing process according to the exemplary second embodiment of the present disclosure.

Referring to FIGS. 9A and 9B, an inductor 1000 according to the second embodiment of the present disclosure includes the body 100 and the coil part 200. The coil part 200 includes the plurality of vertical connection portions 210 passing through the body 100 and the horizontal connection portions 230 connecting the plurality of vertical connection portions to each other.

According to the second embodiment of the present disclosure, the body 100 of the inductor 1000 is made of the anodic oxide film material, and contains numerous pores 110 therein. Some of the pores 110 are filled with a magnetic material to form magnetic column portions 315, and other pores 110 not filled with the magnetic material form the air column portions 317 in hollow shapes.

According to the second embodiment of the present disclosure, the inductor 1000 includes the magnetic column portions 315 and the air column portions 317. The magnetic column portions 315 serve to increase the inductance of the inductor 1000, the air column portions 317 serve to insulate between the vertical connection portions 210 and the magnetic part 300. Therefore, the air column portions 317 may prevent heat generated in the coil part 200 from being transmitting to the magnetic part 300 and heat generated in the magnetic part 300 from being transmitted to the coil part 200.

According to the second embodiment of the present disclosure, the inductor 1000 includes a cover part 330. The cover part 330 is provided on at least any one of upper and lower portions of the magnetic column portions 315 and connects the magnetic column portions 315 to each other. The cover part 330 may be made of the same magnetic material as the magnetic column portions 315.

Hereinbelow, referring to FIGS. 10A to 15B, a manufacturing method according to the second embodiment of the present disclosure will be described. In FIGS. 10A to 15B, ‘A’ is a plan view, and ‘B’ is a sectional view taken along line A-A′.

First, referring to FIGS. 10A and 10B, the body 100 made of the anodic oxide film material is prepared. The body 100 is made of the anodic oxide film material. The anodic oxide film means a film formed by anodizing the base metal, and the pores 110 mean holes formed in the process of forming the anodic oxide film by anodizing metal. For example, when the base metal is aluminum (Al) or an aluminum alloy, the anodic oxide film made of aluminum oxide (Al₂O₃) is formed on a surface of the base material when the base material is anodized. The anodic oxide film is divided into the barrier layer in which the pores 100 are not vertically formed and the porous layer in which pores are formed. When the base material is removed from the base material formed on the surface of the anodic oxide film having the barrier layer and the porous layer, only the anodic oxide film made of aluminum oxide (Al₂O₃) remains. Then, the barrier layer formed in anodization is removed and the pores 110 are formed to be hollow in the vertical direction.

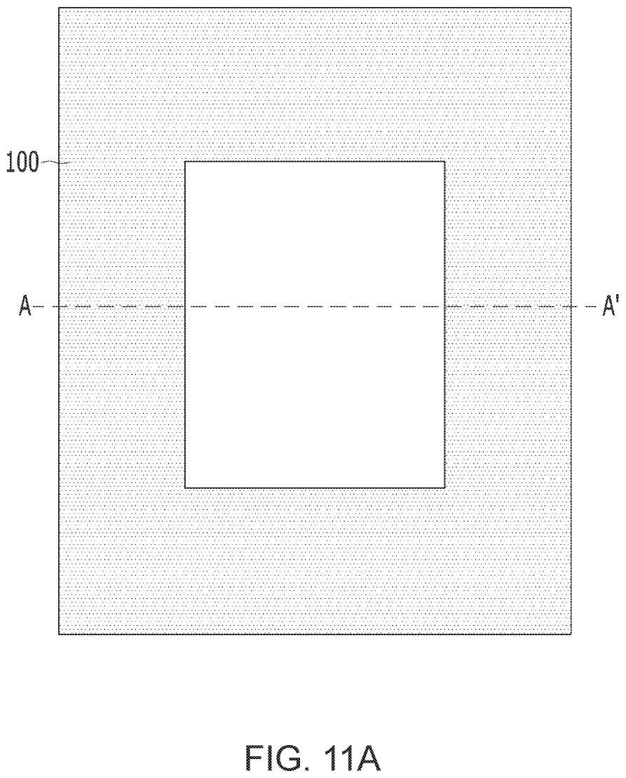

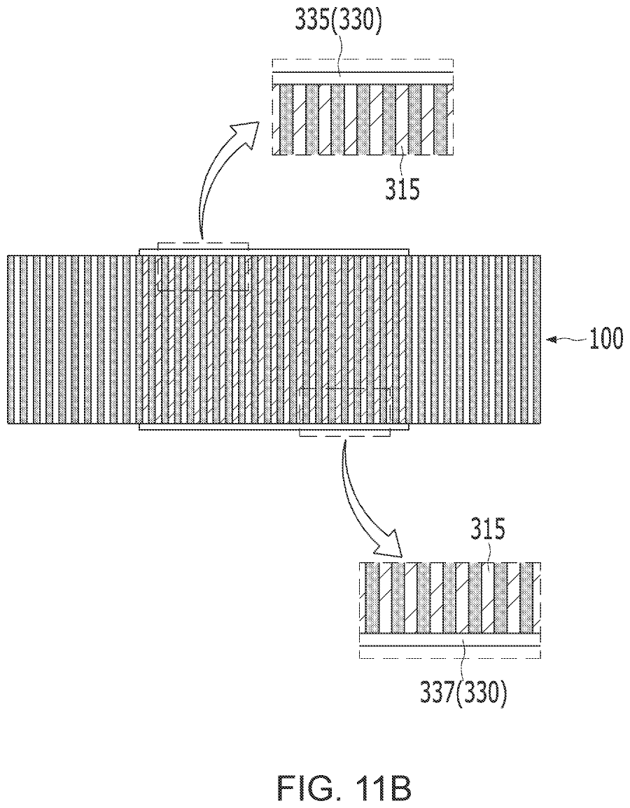

Next, referring to FIGS. 11A and 11B, the pores 110 of the body 100 are filled with the magnetic material to form the plurality of magnetic column portions 315. Since each of the pores 110 has a diameter of several nm to several hundred nm, each of the magnetic column portions 315 also has a diameter of several nm to several hundred nm.

The pores 110 are formed throughout the body 100, but the magnetic column portions 315 are formed only in a part of areas of the body 100. Therefore, the body 100 includes the magnetic column portions 315 formed by filling the magnetic material in the pores 110 and the air column portions 317 not filled with the magnetic material.

The cover part 330 includes a first cover part 335 provided on upper portions of the magnetic column portions 315 and a second cover part 337 provided on lower portions of the magnetic column portions 315. The cover part 330 is provided on at least any one of the upper portions and the lower portions of the magnetic column portions 315 to connect the magnetic column portions 315 to each other. The cover part 330 may be made of the same magnetic material as the magnetic column portions 315.

The magnetic column portions 315 may be formed using the first cover part 335 or the second cover part 337. By using the first cover part 335 or the second cover part 337 as a seed layer for plating, and the magnetic column portions 315 may be formed by plating the insides of the pores 110. The plurality of magnetic column portions 315 is connected to each other to be advantageous in terms of the continuity of magnetic flux. Therefore, the first cover part 335 and the second cover part 337 connecting the magnetic column portions 315 to each other are respectively formed on the upper portions and the lower portions of the magnetic column portions 315.

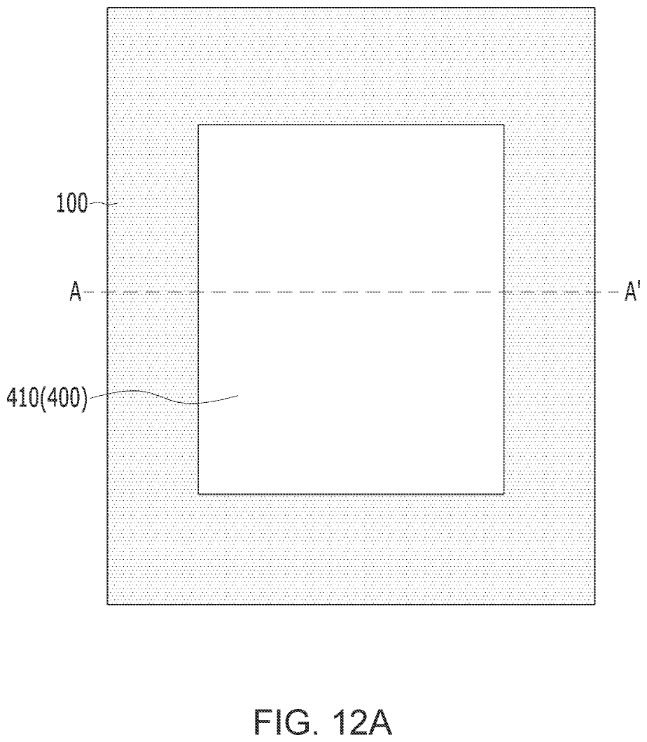

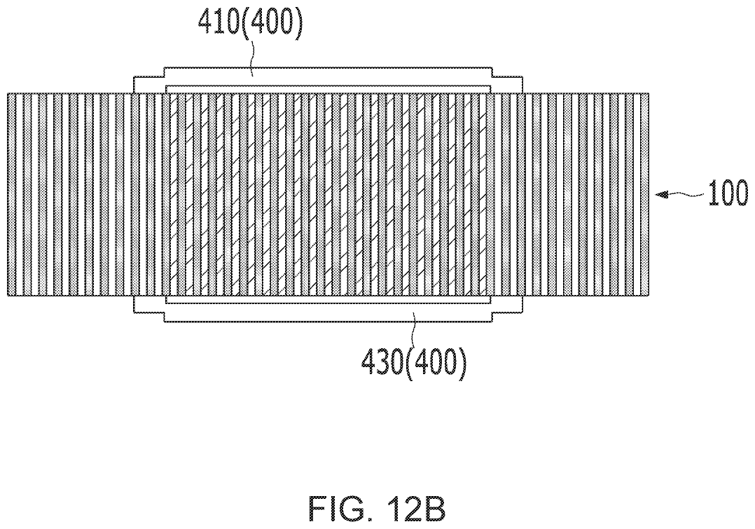

Next, referring to FIGS. 12A and 12B, the passivation layer 400 is provided to cover throughout the cover part 330. As the passivation layer 400 is provided, the cover part 330 is prevented from being exposed. The passivation layer 400 serves not only to protect the magnetic part 300, but also to insulate the magnetic part 300 from the outside thereof. The passivation layer 400 includes the first passivation layer 410 and the second passivation layer 430. The first passivation layer 410 is formed to cover throughout the first cover part 335 and the second passivation layer 430 is formed to cover throughout the second cover part 337.

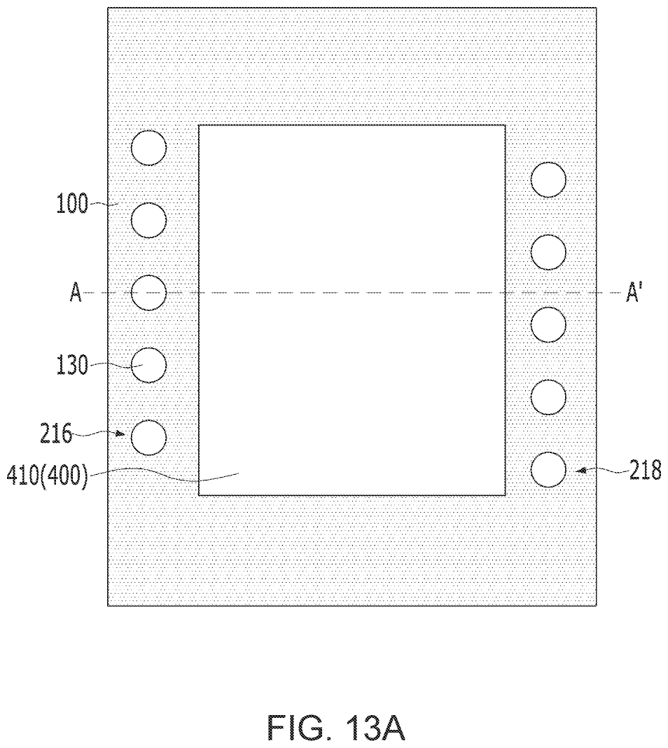

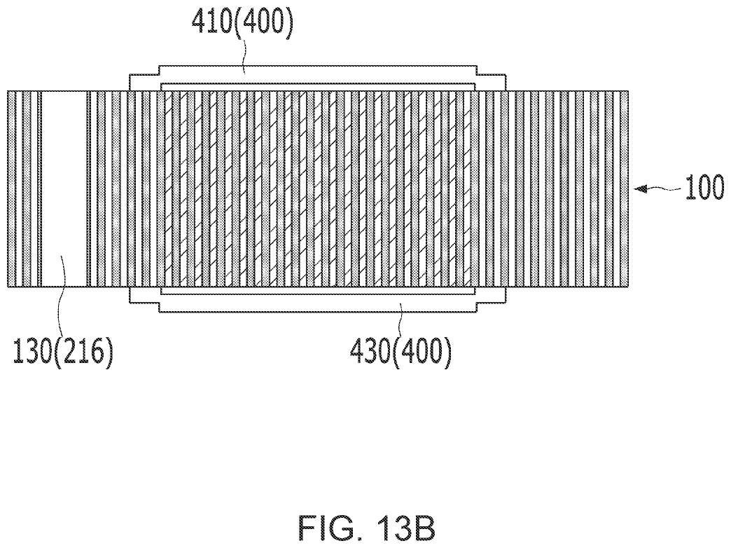

Next, referring to FIGS. 13A and 13B, the vertical through parts 130 are formed. The vertical through parts 130 may be formed separately from the pores 110 by etching the anodic oxide film. The vertical through parts 130 are formed to have the widths greater than the widths of the pores 110. Preferably, the vertical through parts 130 may have the widths equal to or greater than 1 μm and less than or equal to 10 μm. The vertical through parts 130 include first row vertical through parts 216 provided at the left side based on the views and second row vertical through parts 218 provided at the right side based on the views. Each of the vertical through parts 130 is shown as having the circular horizontal section, but the present disclosure is not limited thereto, and the horizontal section of the vertical through part 130 may be formed in a polygonal shape. The vertical through parts 130 arranged in the column direction are spaced apart from each other at a distance equal to or greater than 1 μm and less than or equal to 50 μm.

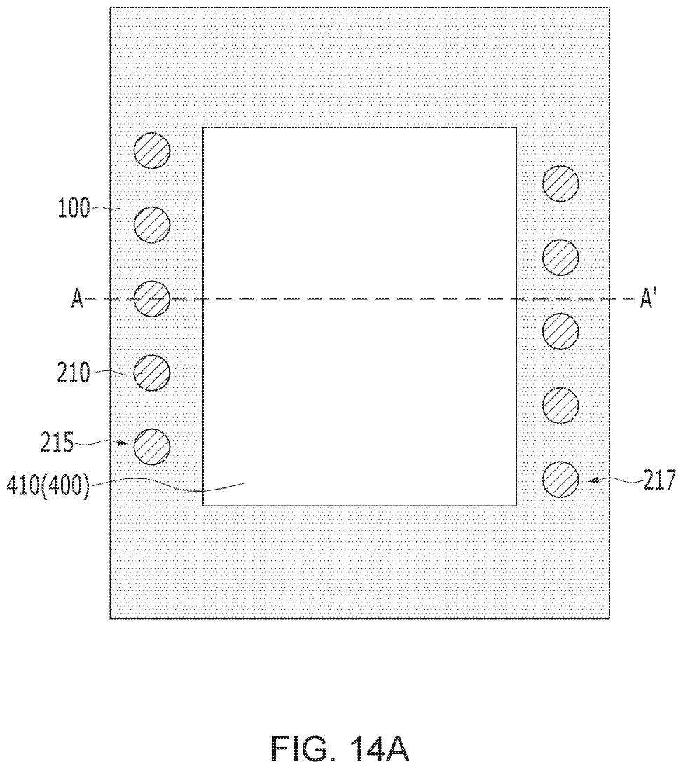

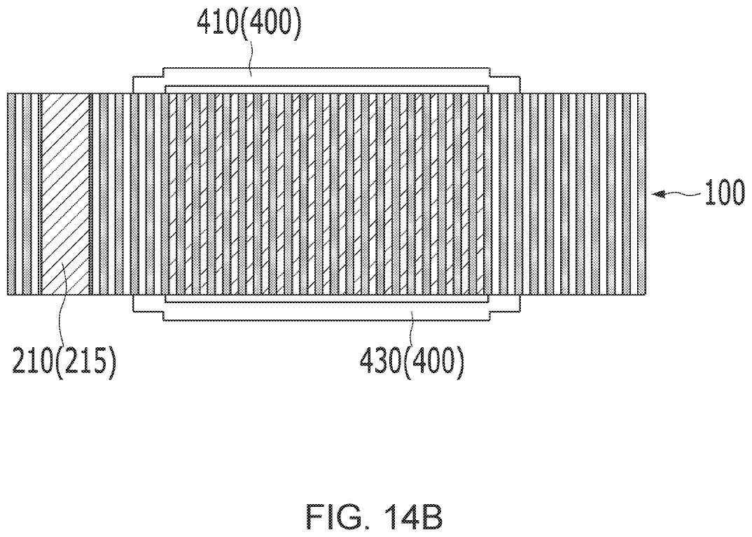

Next, referring to FIGS. 14A and 14B, the vertical connection portions 210 are formed by filling the electric conductive material into the vertical through parts 130. The vertical connection portions 210 may be formed by filling the electric conductive material into the vertical through parts 130 by using the plating method, the injection method, etc.

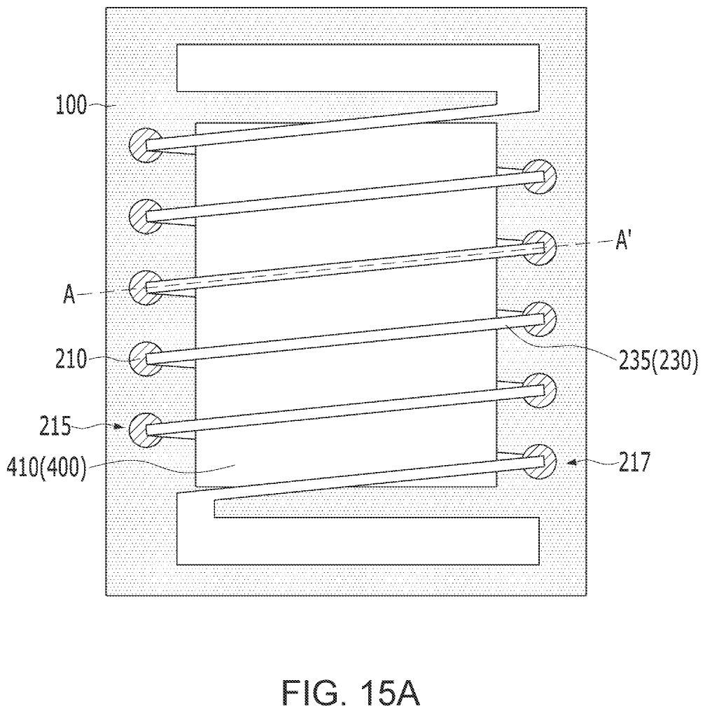

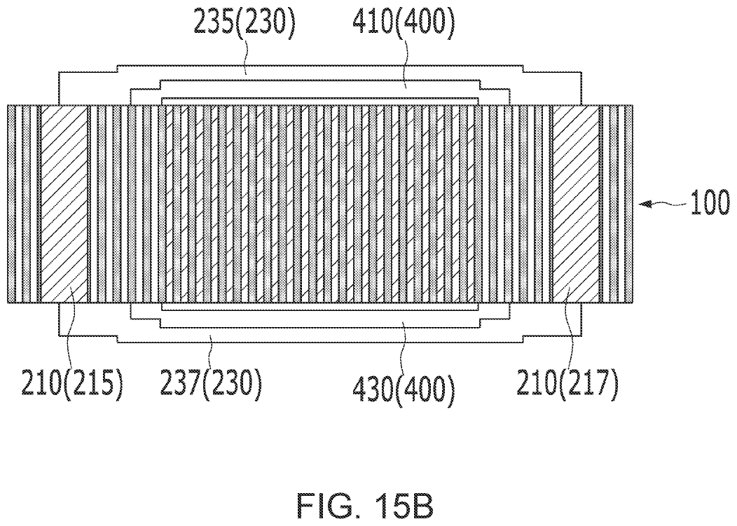

Next, referring to FIGS. 15A and 15B, on the upper surface of the body 100, some of the vertical connection portions 210 included in the first column vertical connection portions 215 and remaining vertical connection portions 210 included in the second column vertical connection portions 217 are connected to each other to form the upper connection portions 235. The upper connection portions 235 are formed in diagonal lines. The upper connection portions 235 may be formed using a known metal patterning technique.

Furthermore, on the lower surface of the body 100, some of the vertical connection portions 210 included in the first column vertical connection portions 215 and remaining vertical connection portions 210 in the second column vertical connection portions 217 are connected to each other to form the lower connection portions 237. The lower connection portions 237 are formed in diagonal lines. The lower connection portions 237 may be formed using a known metal patterning technique.

Meanwhile, in a next stage, additional process may be performed to improve product reliability. For example, an insulation with high rigidity may be additionally formed on the upper and lower surfaces of the body 100. Through the above process, the inductor 1000 according to the second embodiment of the present disclosure is manufactured.

As a modification of the second embodiment of the present disclosure, instead of filling in the pores 110 with the magnetic material to form the magnetic column portions 315, the plurality of magnetic column portions may be formed by etching the anodic oxide film to form etching holes having the widths greater than the widths of the pores 110 separately from the pores 110 and by filling the etching holes with the magnetic material. In the modification of the second embodiment of the present disclosure, the etching holes are formed separately from the pores 110 and the etching holes are filled with the magnetic material to form the magnetic column portions 315, the above method is different from the configuration of the second embodiment in which the pores 110 is directly filled with the magnetic material. Even in according to the modification of the second embodiment of the present disclosure, the inductor may include the first cover part connecting the upper portions of the plurality of magnetic column portions to each other and the second cover part connecting the lower portions of the plurality of magnetic column portions to each other.

Hereinbelow, a third embodiment according to the present disclosure will be described. However, embodiments described below will be described by focusing on the characteristic components in comparison to the first embodiment, and the same or similar components to the components of the first embodiment will be omitted.

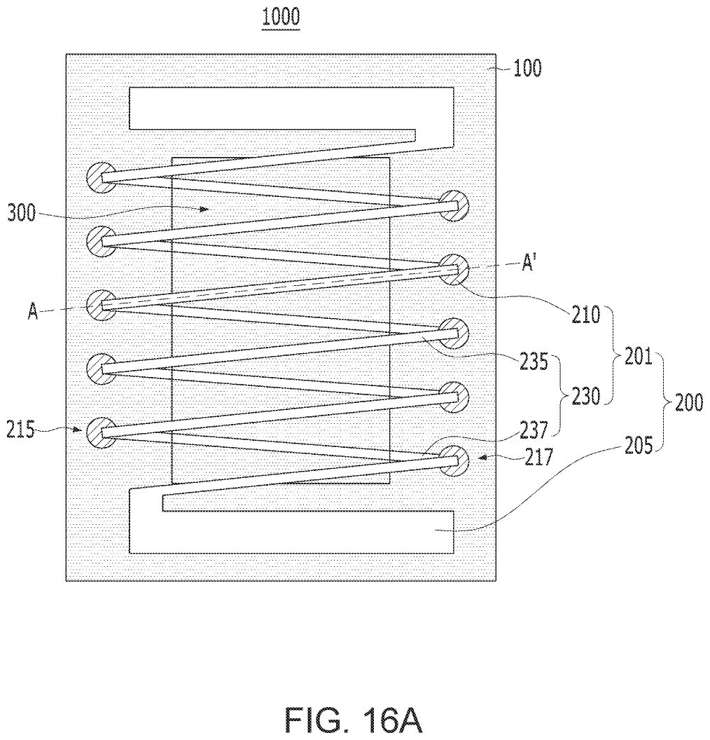

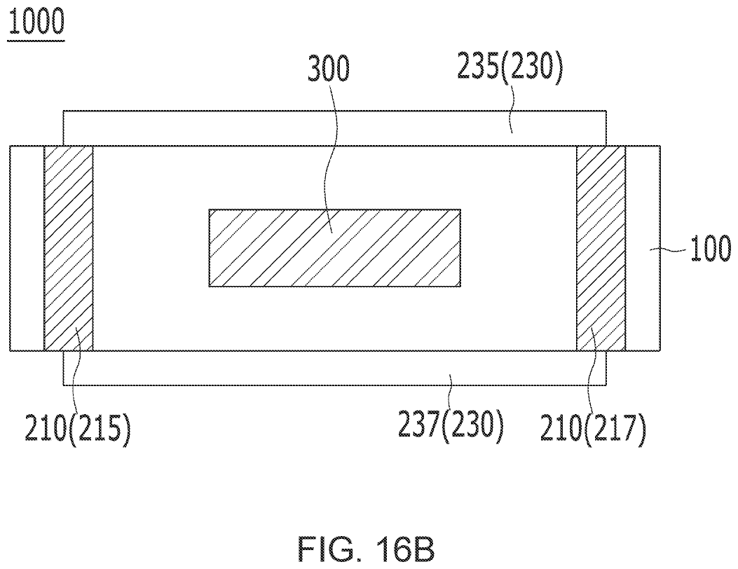

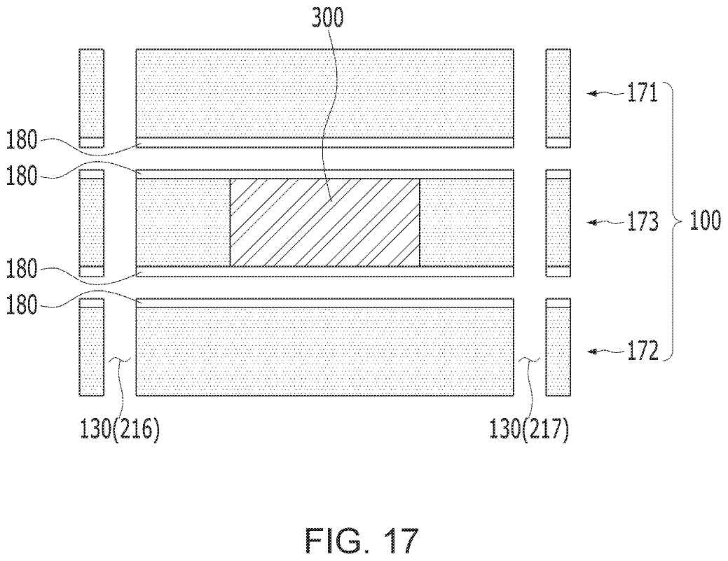

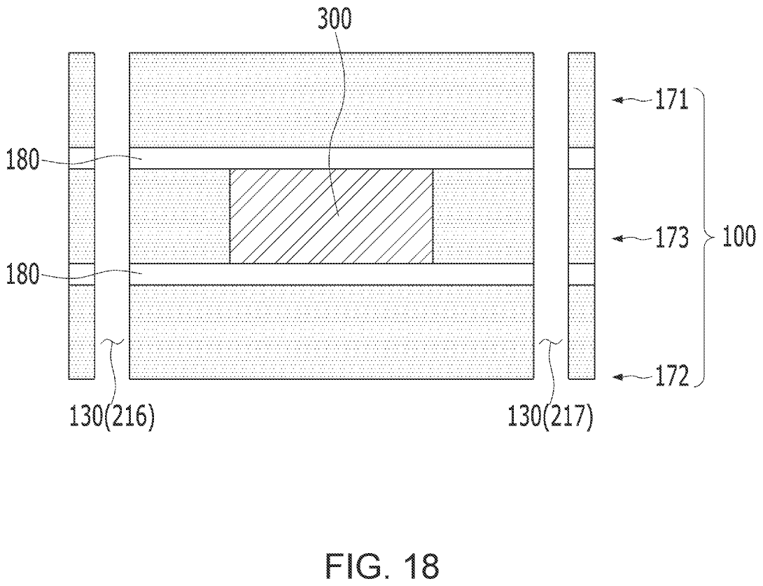

FIG. 16A is a plan view showing an exemplary third embodiment of the present disclosure. FIG. 16B is a sectional view taken along line A-A′ in FIG. 16A. FIGS. 17 to 20B are views showing a manufacturing process according to the exemplary third embodiment of the present disclosure. In FIGS. 17 to 20B, ‘A’ is a plan view, and ‘B’ is a sectional view taken along line A-A′.

The inductor 1000 according to the third embodiment of the present disclosure includes the body 100 and the coil part 200. The coil part 200 includes the plurality of vertical connection portions 210 passing through the body 100 and the horizontal connection portions 230 connecting the plurality of vertical connection portions to each other. The magnetic part 300 is formed to be embedded inside the body 100. Since the magnetic part 300 is prevented from being exposed as being embedded inside an insulated body 100, there is no need to provide the passivation layer 400 of the first and second embodiments.

According to the third embodiment of the present disclosure, the inductor 1000 is configured such that a plurality of unit bodies are vertically laminated to increase the height thereof, so that the inductor has an advantage of increasing the inductance of the inductor.

Hereinbelow, referring to FIGS. 17 to 20B, a manufacturing method according to the third embodiment of the present disclosure will be described. In FIGS. 17 to 20B, ‘A’ is a plan view, and ‘B’ is a sectional view taken along line A-A′.

First, referring to FIG. 17, the insulated body 100 is provided. The body 100 may be made of the glass material or the anodic oxide film material, but the present disclosure is not limited thereto.

The body 100 includes an upper body 171, a lower body 172, and an intermediate body 173 disposed between the upper body 171 and the lower body 172. The intermediate body 173 includes the magnetic part 300. The magnetic part 300 may be provided in the intermediate body 173.

The vertical through parts 130 are provided in the upper body 171, the intermediate body 173, and the lower body 172. The reason for forming the vertical through parts 130 in advance before the upper body 171, the intermediate body 173, and the lower body 172 are joined to each other is that a forming process of the vertical through parts 130 may become difficult due to joining layers 180 provided between the upper body 171, the intermediate body 173, and the lower body 172.

At least one of the joining layers 180 is disposed between the upper body 171 and the intermediate body 173, and at least one of the joining layers 180 is disposed between the intermediate body 173 and the lower body 172.

The joining layers 180 may be provided by a photolithography process. Therefore, the joining layers 180 may be made of a photosensitive material having a photosensitive property. As an example, the joining layers 180 may be dry film photoresist (DFR). Furthermore, the joining layers 180 serve a joining function to join the upper body 171, the intermediate body 173, and the lower body 172 to each other, so that the joining layers 180 may be configured to have a joining property. Therefore, the joining layers 180 may be configured to have both the photosensitive property and the joining property. When a material of the joining layers 180 described above is used, in addition to the joining function, the joining layers 180 may serve a mask function that may be used to form the vertical through parts 130 in the body 100 of the anodic oxide film material by using opening areas of the joining layers 180.

Meanwhile, the joining layers 180 may be thermosetting resin. The thermosetting resin material may be a polyimide resin, a polyquinoline resin, a polyamideimide resin, an epoxy resin, a polyphenylene ether resin, a fluororesin, etc.

Furthermore, the joining layers 180 may be provided as ceramic joining layers. The ceramic joining layers has an advantage of allowing the inductor 1000 to be used even in high temperature environment.

Furthermore, the joining layers 180 may be provided as solder.

Next, referring to FIG. 18, the upper body 171, the intermediate body 173, and the lower body 172 are joined using the joining layers 180. As a result, the vertical through parts 130 may penetrate the upper body 171, the intermediate body 173, and the lower body 172 vertically as a whole.

The magnetic part 300 is formed to be embedded inside the body 100. Since the magnetic part 300 is prevented from being exposed from the inside of the insulated body 100, the passivation layer 400 is not required differently from the first and second embodiments.

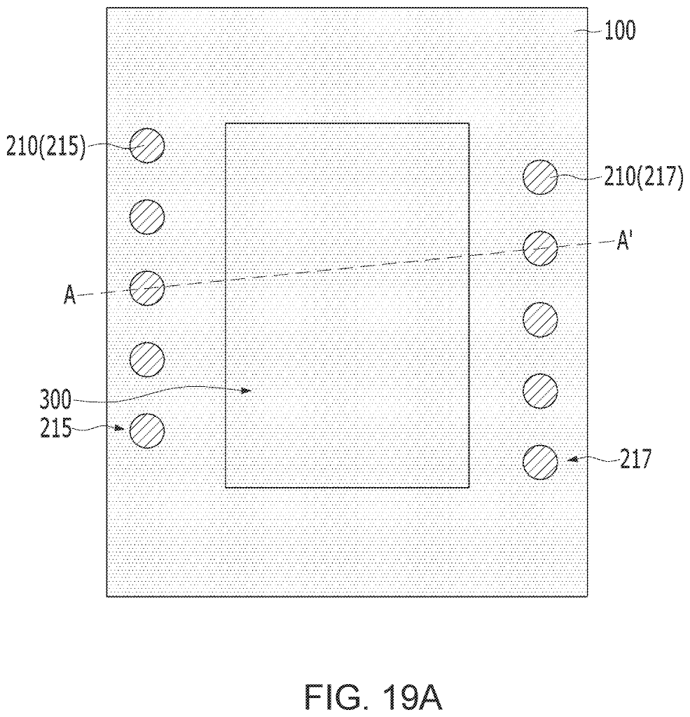

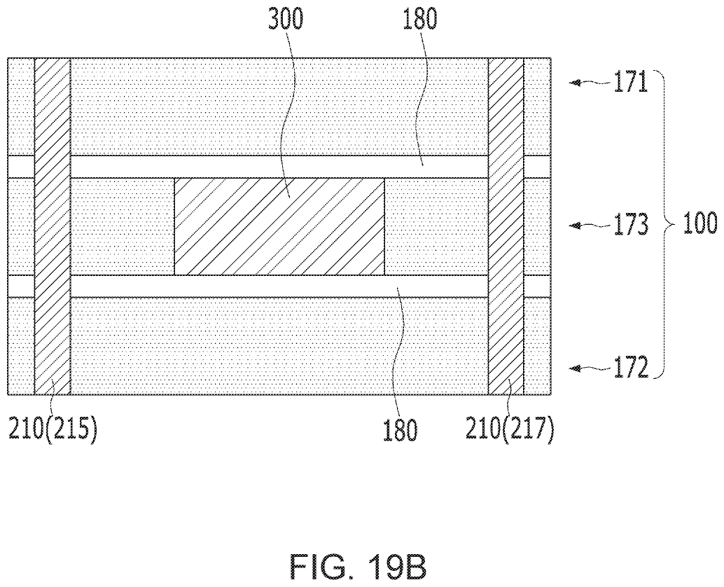

Next, referring to FIGS. 19A and 19B, the vertical connection portions 210 are formed by filling the electric conductive material into the vertical through parts 130.

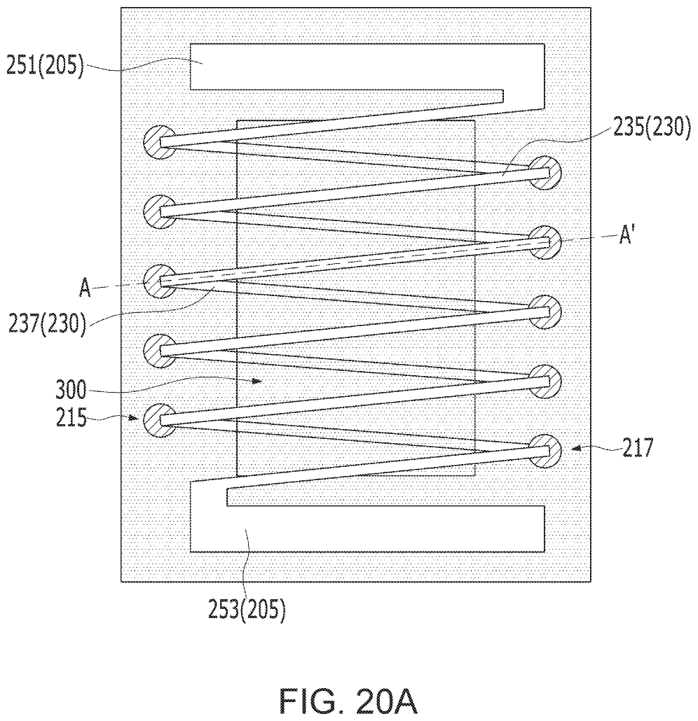

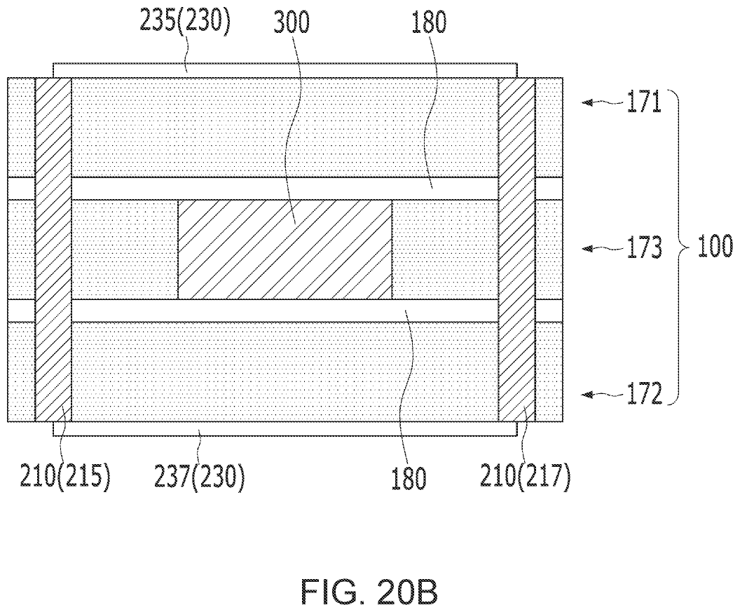

Next, referring to FIGS. 20A and 20B, on the upper surface of the body 100, some of the vertical connection portions 210 included in the first column vertical connection portions 215 and remaining vertical connection portions 210 included in the second column vertical connection portions 217 are connected to each other to form the upper connection portions 235. Furthermore, on the lower surface of the body 100, some of the vertical connection portions 210 included in the first column vertical connection portions 215 and remaining vertical connection portions 210 in the second column vertical connection portions 217 are connected to each other to form the lower connection portions 237.

Meanwhile, in a next stage, additional process may be performed to improve product reliability. For example, an insulation with high rigidity may be additionally formed on the upper and lower surfaces of the body 100. Through the above process, the inductor 1000 according to the second embodiment of the present disclosure is manufactured.

In the description of the previous manufacturing methods, after the upper body 171, the intermediate body 173, and the lower body 172 that have the vertical through parts 130 are joined, the electric conductive material is filled in the vertical through parts 130 to form the vertical connection portions 210. Otherwise, after filling the vertical through parts 130 of the upper body 171, the intermediate body 173, and the lower body 172 with the electric conductive material, the vertical connection portions 210 are aligned and the upper body 171, the intermediate body 173, and the lower body 172 are joined together. Then, a vertical connection portion 210 between the upper body 171 and the intermediate body 173 may be joined to each other by soldering, and a vertical connection portion 210 between the intermediate body 173 and the lower body 172 may be joined to each other by soldering.

As a modification of the third embodiment of the present disclosure, the insulated body 100 consists only of the upper body 171 and the lower body 172, and (i) the magnetic part 300 is included in at least one of the upper body 171 and the lower body 172, (ii) the magnetic part 300 is included on joining surfaces between the upper body 171 and the lower body 172, (iii) the magnetic part 300 is provided in at least one of the upper body 171 and the lower body 172 and exposed to the joining surfaces thereof, or (iv) the magnetic part 300 is provided by vertically penetrating at least one of the upper body 171 and the lower body 172.

Hereinbelow, the body part for the inductor 1000 according to an exemplary embodiment of the present disclosure will be described. According to the exemplary embodiment of the present disclosure, the body part for the inductor 1000 may be configured by including at least any one of configurations of the first to third embodiments and the modifications, and the present disclosure is not limited to a configuration described below. However, an exemplary embodiment as the body part for the inductor 1000 will be described will be described.

The body part for the inductor 1000 may be made of the anodic oxide film material, and may include the body 100 having the vertical through parts 130 vertically penetrating the anodic oxide film.

The body part for the inductor 1000 may include the vertical connection portions 210 formed by filling the vertical through parts 130 with the electric conductive material.

The body part for the inductor 1000 may include the upper connection portions 235 connecting the upper portions of the vertical connection portions 210 to each other and the lower connection portions 237 connecting the lower portions of the vertical connection portions 210 to each other. The body part for the inductor 1000 may include the coil part 200, the coil part 200 may include the vertical connection portions 210 provided inside the body 100 and the horizontal connection portions 230 provided outside the body 100.

The vertical connection portions 210 provided in the body part for the inductor 1000 may include the first column vertical connection portions 215 located at the first side of the body 100 and the second column vertical connection portions 217 located at the second side of the body 100. The body part for the inductor 1000 may include the magnetic part 300 provided in the body 100 while being located between the first column vertical connection portions 215 and the second column vertical connection portions 217.

The body part for the inductor 1000 may include the passivation layer 400 covering the magnetic part 300. Furthermore, in the body part for the inductor 1000, the body 100 may have a thickness equal to or greater than 100 μm and less than or equal to 300 μm, the vertical through parts 130 may have a width equal to or greater than 1 μm and less than or equal to 20 μm, the space between the vertical through parts 130 arranged in the column direction may be a distance equal to or greater than 1 μm and less than or equal to 50 μm, and the vertical through parts 130 may have a horizontal section formed in a polygonal shape.

As described above, although the preferred embodiments of the present disclosure have been described for illustrative purposes, those skilled in the art will appreciate that various modifications, additions and substitutions are possible, without departing from the scope and spirit of the invention as disclosed in the accompanying claims.

### DESCRIPTION FOR REFERENCE NUMERALS

100: body
200: coil part
300: magnetic part
400: passivation layer

1. An inductor comprising a body and a coil part, wherein the coil part comprises:
a plurality of vertical connection portions passing through the body;
upper connection portions provided above the body and connecting the vertical connection portions to each other; and
lower connection portions provided at a lower portion of the body and connecting the vertical connection portions to each other.

2. The inductor of claim 1, wherein the body is made of a glass material.

3. The inductor of claim 1, wherein the body is made of an anodic oxide film material.

4. The inductor of claim 1, wherein the plurality of vertical connection portions comprises:
first column vertical connection portions located at a first side of the body; and
second column vertical connection portions located at a second side of the body,
wherein, when the first column vertical connection portions are reflected toward the second column vertical connection portions, the first column vertical connection portions are located between the second column vertical connection portions.

5. The inductor of claim 1, wherein a magnetic part is provided in the coil part.

6. The inductor of claim 5, further comprising:
a first passivation layer provided between the magnetic part and the upper connection portions; and
a second passivation layer provided between the magnetic part and the lower connection portions.

7. The inductor of claim 5, wherein the magnetic part consists of one bulk.

8. The inductor of claim 5, wherein the magnetic part comprises a plurality of magnetic column portions.

9. The inductor of claim 8, further comprising:
a cover part provided in at least any one of an upper portion and a lower portion of the plurality of magnetic column portions and connecting the magnetic column portions to each other.

10. The inductor of claim 5, wherein the magnetic part is embedded in the body.

11. An inductor comprising a body and a coil part, wherein the coil part comprises:
a plurality of vertical connection portions passing through the body;
upper connection portions provided above the body and connecting the vertical connection portions to each other; and
lower connection portions provided at a lower portion of the body and connecting the vertical connection portions to each other,
wherein the body has a thickness that is equal to or greater than 100 μm and less than or equal to 200 μm,
each of the vertical connection portions has a width that is equal to or greater than 1 μm and less than or equal to 10 μm,
each of the upper connection portions has a width that is equal to or greater than 1 μm and less than or equal to 10 μm, and
each of the lower connection portion has a width equal to or greater than 1 μm and less than or equal to 10 μm.

12. An inductor comprising a body and a coil part, wherein the coil part comprises:
a plurality of vertical connection portions passing through the body;
upper connection portions provided above the body and connecting the vertical connection portions to each other; and
lower connection portions provided at a lower portion of the body and connecting the vertical connection portions to each other,
a space between the first column vertical connection portions located at the first side of the body has a distance equal to or greater than 1 μm and less than or equal to 10 μm, and
a space between the second column vertical connection portions located at the second side of the body has a distance equal to or greater than 1 μm and less than or equal to 10 μm.

13. An inductor comprising a body and a coil part, wherein the coil part comprises:
a plurality of vertical connection portions passing through the body;
upper connection portions provided above the body and connecting the vertical connection portions to each other; and
lower connection portions provided at a lower portion of the body and connecting the vertical connection portions to each other,
wherein a pitch distance in the coil part is equal to or greater than 1 μm and less than or equal to 10 μm.

14. An inductor comprising:
a body made of an anodic oxide film material;
a coil part comprising a plurality of vertical connection portions passing through the body and horizontal connection portions provided on a surface of the body and connecting the vertical connection portions to each other; and
a magnetic part provided in the body and located inside the coil part.

15. The inductor of claim 14, further comprising:
a passivation layer provided between the magnetic part and the coil part.

16. The inductor of claim 14, wherein each of the vertical connection portions and each of the horizontal connection portions have sectional areas that are identical.

17. (canceled)

18. (canceled)

19. (canceled)

20. (canceled)

21. (canceled)

22. (canceled)

23. (canceled)

24. (canceled)
